(19) United States
(12) Patent Application Publication
(10) Pub. No.: US 2025/0196116 A1
(43) Pub. Date: Jun. 19, 2025

(54) Tertiary Pnictogenium-Borane Catalyst Compounds and use Thereof

(71) Applicant: ExxonMobil Chemical Patents Inc., Spring, TX (US)

(72) Inventors: Tzu-Pin Lin, Houston, TX (US); Jonathan J. Schaefer, Baytown, TX (US); Matthew W. Holtcamp, Humble, TX (US); Gursu Culcu, Humble, TX (US); Francis C. Rix, Houston, TX (US); Nikola S. Lambic, Seabrook, TX (US); Irene C. Cai, Webster, TX (US); Eryn G. Lee, Spring, TX (US); Hua Zhou, Missouri City, TX (US)

(21) Appl. No.: 18/848,824

(22) PCT Filed: Mar. 9, 2023
(86) PCT No.: PCT/US2023/064022

§ 371 Date: Sep. 19, 2024

Related U.S. Application Data
(60) Provisional application No. 63/325,445, filed on Mar. 30, 2022.
(60) Provisional application No. 63/392,028, filed on Jul. 25, 2022.

(51) Int. Cl. B01J 31/14; C08G 64/34; C08G 65/26

(52) U.S. Cl. CPC B01J 31/146; C08G 64/34; C08G 65/2675; B01J 2523/305; B01J 2523/51

(57) ABSTRACT

Embodiments described herein relate to tertiary pnictogenium-borane catalyst complexes for the polymerization of one or more epoxides and one or more of CO₂, COS, and CS₂. The catalysts can also polymerize cyclic monomers such as lactones and lactide.

This application claims the benefit of and priority to both U.S. Provisional Application No. 63/325,445 filed Mar. 30, 2022 and U.S. Provisional Application No. 63/392,028 filed Jul. 25, 2022, the disclosure of which is incorporated herein by reference.

### TECHNOLOGICAL FIELD

This invention relates to novel tertiary pnictogenium-borane catalyst complexes uses thereof, such as the generation of polymers and block copolymers of polycarbonate and polyesters.

### BACKGROUND

Polymerization catalysts are of great use in industry. Hence there is interest in finding new catalyst systems that increase the commercial usefulness of the catalyst and allow the production of polymers having improved properties.

Copolymerization of CO₂ and epoxide to produce polycarbonates is a challenging reaction. The more significant challenges include: (1) the polymerization is usually mediated by transition metal-based catalysts which are expensive, (2) the activity is usually low, typically with turnover numbers of less than 1,000 per catalyst, and (3) the conventional catalysts are hindered by water, alcohols, and carboxylic acids which are typically used as chain-transfer-agents to control polymer architecture and molecular weight.

Patent application US2021/0363297-A1 describes the use of quaternary ammonium- and phosphonium-borane systems in copolymerization of CO₂ and epoxides. The reported quaternary pnictogenium system showed good selective for the formation of polyalkylene carbonate at 80° C. In sharp contrast, the novel tertiary pnictogenium system disclosed herein operates at higher, more desired temperatures (>90° C., see examples section).

### SUMMARY

Exemplary embodiments described herein relate to a tertiary pnictogenium-borane catalyst complex represented by the Formula (I):

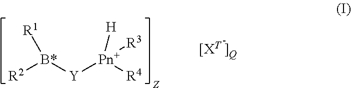

where Pn is a group 15 pnictogen element, preferably nitrogen or phosphorus, or more preferably phosphorus;
Pn+constitutes a cationic tertiary pnictogenium moiety wherein the pnictogen is covalently bonded to one hydrogen atom, as well as non-hydrogen Y, R³, and R⁴ groups;
(the number of pnictogenium moieties, Pn+)×Z=T×Q;
B* is a group 13 element, preferably boron or aluminum, or more preferably boron;
Z is 1, 2, 3, 4, 5, 6, 7, 8, 9, or 10; where if Z is greater than 1, then the catalyst units are present individually or are bound together in linear, branched or cyclic groups;
T is 1, 2, 3, 4, 5, 6, 7, 8, 9, or 10, indicating the anionic charge of X;
Q is 1, 2, 3, 4, 5, 6, 7, 8, 9, or 10, indicating the number of X present;
each of R¹, R², R³ and R⁴ is independently a hydrocarbyl group, a non-halogenated substituted hydrocarbyl, or a heteroatom-containing group, and can optionally comprise a tri-substituted borane or cationic tertiary pnictogenium moiety;
Y is independently a linking group having 1 to 50 non-hydrogen atoms, preferably 2 to 40 non-hydrogen atoms, more preferably 3 to 10 non-hydrogen atoms, preferably a trimethylene, a tetramethylene, a pentamethylene, a hexamethylene, a heptamethylene, an octamethylene, —CH₂CH₂Si(Me₂)—CH₂CH₂—, or —CH₂(C₆H₄)—CH₂—; and
X is independently a mono-anionic group, a multi-anionic group, or a combination thereof.

Embodiments described herein relate to pnictogenium-borane catalyst compositions represented by Formula (I) wherein the substituted hydrocarbyl (such as substituted alkyl, and substituted aryl) is substituted with a catalyst composition represented by the Formula (I), a group 13 metal-containing moiety of Formula (I) (such as a boron-containing moiety of Formula (I)), and/or a pnictogenium-containing moiety of Formula (I). A “boron-containing moiety of Formula (I)” or a “group 13 metal-containing moiety of Formula (I)” is that part of Formula (I) not containing the pnictogenium fragment, e.g., P(R³)(R⁴). A “pnictogenium-containing moiety of Formula (I)” is that part of Formula (I) not containing the group 13 metal (such as boron) fragment, e.g., B*(R¹)(R²).

### DETAILED DESCRIPTION

To address the above needs, among other things, a catalyst family based on tertiary pnictogen-boranes and pnictogenium-boranes has been developed. These catalysts can facilitate the copolymerization of epoxides and CO₂ under a wide range of temperatures from 25° C. to 180° C. These catalysts are inexpensive and metal-free, often showing excellent activity for CHO/CO₂ copolymerization with turnover numbers of 1,000 or more. In the presence of bifunctional or multi-functional chain-transfer-agents, these catalysts can produce additional telechelic polymer chains.

### Definitions

For the purposes of this invention and the claims thereto, the new numbering scheme for the Periodic Table Groups is used as described in Chemical and Engineering News, v.3(5), pg. 27 (1985). For example, a “group 4 metal” is an element from group 4 of the Periodic Table, e.g. Hf, Ti, or Zr.

The terms “substituent,” “radical,” “group,” and “moiety” may be used interchangeably.

“Conversion” is the amount of monomer that is converted to polymer product, and is reported as mol % and is calculated based on the polymer yield and the amount of monomer fed into the reactor.

“Catalyst activity” is a measure of how active the catalyst is and is reported as the grams of product polymer (P) produced per millimole of catalyst (cat) used per hour (gP·mmolcat⁻¹·h⁻¹).

The term “heteroatom” refers to any group 13-17 element, excluding carbon. A heteroatom may include B, Si, Ge, Sn, N, P, As, O, S, Se, Te, F, Cl, Br, and I. The term “heteroatom” may include the aforementioned elements with hydrogens attached, such as BH, BH₂, SiH₂, OH, NH, NH₂, etc. The term “substituted heteroatom” describes a heteroatom that has one or more of these hydrogen atoms replaced by a hydrocarbyl or substituted hydrocarbyl group(s).

The term “hydrocarbon” is a class of compounds consisting of the elements carbon (C) and hydrogen (H) only.

The term “hydrocarbyl” means a univalent group formed by removing a hydrogen atom from a hydrocarbon.

Unless otherwise indicated, (e.g., the definition of “substituted hydrocarbyl”, “substituted aromatic”, etc.), the term “substituted” means that at least one hydrogen atom has been replaced with at least one non-hydrogen group, such as a hydrocarbyl group, a heteroatom, or a heteroatom containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, where each R* is independently a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

The term “substituted hydrocarbyl” means a hydrocarbyl radical in which at least one hydrogen atom of the hydrocarbyl radical has been substituted with at least one heteroatom (such as halogen, e.g., Br, Cl, F or I) or heteroatom-containing group (such as a functional group, e.g., —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, where each R* is independently a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring. The term “hydrocarbyl substituted phenyl” means a phenyl group having 1, 2, 3, 4 or 5 hydrogen groups replaced by a hydrocarbyl or substituted hydrocarbyl group. For example, the “hydrocarbyl substituted phenyl” group can be represented by the formula:

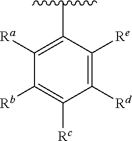

where each of R^{a}, R^{b}, R^{c}, R^{d}, and R^{e} can be independently selected from hydrogen, C₁-C₄₀ hydrocarbyl or C₁-C₄₀ substituted hydrocarbyl, a heteroatom or a heteroatom-containing group (provided that at least one of R^{a}, R^{b}, R^{c}, R^{d}, and R^{e} is not H), or two or more of R^{a}, R^{b}, R^{c}, R^{d}, and R^{e} can be joined together to form a C₄-C₆₂ cyclic or polycyclic hydrocarbyl ring structure, or a combination thereof.

The term “non-halogenated” excludes Group 17 elements. For example, the term “non-halogenated substituted hydrocarbyl” means a substituted hydrocarbyl radical that does not comprise any Group 17 element.

The term “substituted aromatic,” means an aromatic group having 1 or more hydrogen groups replaced by a hydrocarbyl, substituted hydrocarbyl, heteroatom or heteroatom containing group.

The term “substituted phenyl,” mean a phenyl group having 1 or more hydrogen groups replaced by a hydrocarbyl, substituted hydrocarbyl, heteroatom or heteroatom containing group.

The terms dihydrocarbylamino and dihydrocarbylphosphino mean a nitrogen or phosphorus group bonded to two hydrocarbyl groups. Examples of suitable dihydrocarbylamino and dihydrocarbylphosphino groups can include dimethylamino, dimethylphosphino, diethylamino, diethylphosphino, and all isomers of dipropylamino, dipropylphosphino, dibutylamino, dibutylphosphino, and the like.

The term “tri-substituted borane” means a borane group having 3 hydrogen groups replaced by a hydrocarbyl, substituted hydrocarbyl, heteroatom or heteroatom containing group.

The term “tertiary pnictogenium” means a pnictogenium group having 3 hydrogen groups replaced by a hydrocarbyl, substituted hydrocarbyl, heteroatom or heteroatom containing group, and is also bonded to additional one hydrogen atom.

The term “substituted adamantanyl” means an adamantanyl group having 1 or more hydrogen groups replaced by a hydrocarbyl, substituted hydrocarbyl, heteroatom or heteroatom containing group.

The terms “alkoxy” and “alkoxide” mean an alkyl or aryl group bound to an oxygen atom, such as an alkyl ether or aryl ether group/radical connected to an oxygen atom and can include those where the alkyl/aryl group is a C₁ to C₁₀ hydrocarbyl (also referred to as a hydrocarbyloxy group). The alkyl group may be straight chain, branched, or cyclic. The alkyl group may be saturated or unsaturated. Examples of suitable alkoxy radicals can include methoxy, ethoxy, n-propoxy, iso-propoxy, n-butoxy, iso-butoxy, sec-butoxy, tert-butoxy, phenoxy.

The term “aryl” or “aryl group” means an aromatic ring and the substituted variants thereof, such as phenyl, 2-methyl-phenyl, xylyl, 4-bromo-xylyl. Likewise, heteroaryl means an aryl group where a ring carbon atom (or two or three ring carbon atoms) has been replaced with a heteroatom, such as N, O, or S. As used herein, the term “aromatic” also refers to pseudoaromatic heterocycles which are heterocyclic substituents that have similar properties and structures (nearly planar) to aromatic heterocyclic ligands, but are not by definition aromatic; likewise the term aromatic also refers to substituted aromatics.

The term “arylalkyl” means an aryl group where a hydrogen has been replaced with an alkyl or substituted alkyl group. For example, 3,5′-di-tert-butyl-phenyl indenyl is an indene substituted with an arylalkyl group. When an arylalkyl group is a substituent on another group, it is bound to that group via the aryl.

The term “alkylaryl” means an alkyl group where a hydrogen has been replaced with an aryl or substituted aryl group. For example, phenethyl indenyl is an indene substituted with an ethyl group bound to a benzene group. When an alkylaryl group is a substituent on another group, it is bound to that group via the alkyl.

The term “ring atom” means an atom that is part of a cyclic ring structure. By this definition, a benzyl group has six ring atoms and tetrahydrofuran has 5 ring atoms.

A heterocyclic ring is a ring having a heteroatom in the ring structure as opposed to a heteroatom substituted ring where a hydrogen on a ring atom is replaced with a heteroatom. For example, tetrahydrofuran is a heterocyclic ring and 4-N,N-dimethylamino-phenyl is a heteroatom-substituted ring. Other examples of heterocycles may include pyridine, imidazole, and thiazole.

The terms “hydrocarbyl radical,” “hydrocarbyl group,” or “hydrocarbyl” may be used interchangeably and are defined to mean a group consisting of hydrogen and carbon atoms only. For example, a hydrocarbyl can be a C₁-C₁₀₀ radical that may be linear, branched, or cyclic, and when cyclic, aromatic or non-aromatic. Examples of such radicals may include, but are not limited to, alkyl groups such as methyl, ethyl, propyl (such as n-propyl, isopropyl, cyclopropyl), butyl (such as n-butyl, isobutyl, sec-butyl, tert-butyl, cyclobutyl), pentyl (such as iso-amyl, cyclopentyl) hexyl (such as cyclohexyl), octyl (such as cyclooctyl), nonyl, decyl (such as adamantanyl), undecyl, dodecyl, tridecyl, tetradecyl, pentadecyl, hexadecyl, heptadecyl, octadecyl, nonadecyl, icosyl, henicosyl, docosyl, tricosyl, tetracosyl, pentacosyl, hexacosyl, heptacosyl, octacosyl, nonacosyl, or tricontyl, and aryl groups, such as phenyl, benzyl, and naphthyl.

For purposes of this specification and the claims appended thereto, when a polymer or copolymer is referred to as comprising a monomer (the monomer present in such polymer or copolymer is the polymerized form of the monomer). For example, when a copolymer is said to have a “caprolactone” content of 35 wt % to 55 wt %, it is understood that the mer unit in the copolymer is derived from caprolactone in the polymerization reaction and said derived units are present at 35 wt % to 55 wt %, based upon the weight of the copolymer. A “polymer” has two or more of the same or different mer units. A “homopolymer” is a polymer having mer units that are the same. A “copolymer” is a polymer having two or more mer units that are different from each other. A “terpolymer” is a polymer having three mer units that are different from each other. Accordingly, the definition of copolymer, as used herein, includes terpolymers and the like. “Different” as used to refer to mer units indicates that the mer units differ from each other by at least one atom or are different isomerically. A “polylactone” is a polymer where the mer unit(s) in the polymer are derived from one or more lactones (where the lactone mer units may be ring opened). A “caprolactone polymer” or “caprolactone copolymer” is a polymer or copolymer comprising at least 50 mol % of one or more caprolactone derived units (such as caprolactone, decalactone, or methylcaprolactone).

As used herein, Mn is number average molecular weight, Mw is weight average molecular weight, and Mz is z average molecular weight, wt % is weight percent, and mol % is mole percent. Molecular weight distribution (MWD), also referred to as polydispersity index (PDI), is defined to be Mw divided by Mn. Unless otherwise noted, all molecular weight units (e.g., Mw, Mn, Mz) are reported in units of g/mol (g mol-1).

A “catalyst system” is a combination of at least one catalyst compound, an optional co-activator, an optional chain transfer reagent, and an optional support material. The terms “catalyst compound” and “catalyst complex” are used interchangeably. A polymerization catalyst system is a catalyst system that can polymerize monomers to polymer.

In the description herein, the catalyst may be described as a catalyst, catalyst compound, or a catalyst complex, and these terms are used interchangeably.

The following abbreviations may be used herein: Me is methyl, Et is ethyl, Pr is propyl, cPr is cyclopropyl, nPr is n-propyl, iPr is isopropyl, Bu is butyl, nBu is normal butyl, iBu is isobutyl, sBu is sec-butyl, tBu is tert-butyl, p-tBu is para-tertiary butyl, Hx is hexyl, Cy is cyclohex, Oct is octyl, Ph is phenyl, Cbz is Carbazole, p-Me is para-methyl, Bz and Bn are benzyl (i.e., CH₂Ph), dme is 1,2-dimethoxyethane, tol is toluene, EtOAc is ethyl acetate, TMS is trimethylsilyl, TIBAL is triisobutylaluminum, TNOAL is tri(n-octyl)aluminum, THF (also referred to as thf) is tetrahydrofuran, RT is room temperature (and is 23° C. unless otherwise indicated).

The term “diastereomers” are defined as non-mirror image, non-identical stereoisomers. They occur when two or more stereoisomers of a compound have different configurations at one or more (but not all) of the equivalent (related) stereocenters and are not mirror images of each other

### Pnictogenium-Borane Catalyst Complexes

Exemplary embodiments described herein relate to a tertiary pnictogenium-borane catalyst complex represented by the Formula (I):

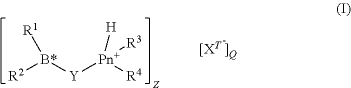

where Pn is a group 15 pnictogen element, preferably nitrogen or phosphorus, or more preferably phosphorus;
Pn+ constitutes a cationic tertiary pnictogenium moiety wherein the pnictogen is covalently bonded to one hydrogen atom, as well as non-hydrogen Y, R³, and R⁴ groups;
(the number of pnictogenium moieties, Pn+)×Z=T×Q;
B* is a group 13 element, preferably boron or aluminum, or more preferably boron;
Z is 1, 2, 3, 4, 5, 6, 7, 8, 9, or 10; where if Z is greater than 1, then the catalyst units are present individually or are bound together in linear, branched or cyclic groups;
T is 1, 2, 3, 4, 5, 6, 7, 8, 9, or 10, indicating the anionic charge of X;
Q is 1, 2, 3, 4, 5, 6, 7, 8, 9, or 10, indicating the number of X present;
each of R¹, R², R³ and R⁴ is independently a hydrocarbyl group, a non-halogenated substituted hydrocarbyl, or a heteroatom-containing group, and can optionally comprise a tri-substituted borane or cationic tertiary pnictogenium moiety;
Y is independently a linking group having 1 to 50 non-hydrogen atoms, preferably 2 to 40 non-hydrogen atoms, more preferably 3 to 10 non-hydrogen atoms, preferably a trimethylene, a tetramethylene, a pentamethylene, a hexamethylene, a heptamethylene, an octamethylene, —CH₂CH₂Si(Me₂)—CH₂CH₂—, or —CH₂(C₆H₄)—CH₂—; and
X is independently a mono-anionic group, a multi-anionic group, or a combination thereof.

In some embodiments of Formula (I), R¹, R², R³, R⁴, and Y do not comprise a Group 2 to 12 metal. In some embodiments of Formula (I), R¹, R², R³, R⁴, and Y do not comprise a Group 3 to 11 transition metal.

In some embodiments of Formula (I), R¹, R², R³, and R⁴ are hydrocarbons that contain 0, 1, or 2 B* moieties, and 0, 1, or 2 Pn moiety, and 0, 1, or 2 Pn+.

In some embodiments of Formula (I), R¹, R², R³, and R⁴ contain heteroatoms to form heteroatom-C or heteroatom-Pn or heteroatom-B* bonds.

In some embodiments of Formula (I), each R¹, R², R³, and R⁴ is independently an alkyl, substituted alkyl, aryl, or substituted aryl group, such as a C₁ to C₅₀ (such as C₂ to C₃₀, such as C₃ to C₂₀) alkyl, C₁ to C₅₀ (such as C₂ to C₃₀, such as C₃ to C₂₀) substituted alkyl, C₅ to C₅₀ (such as C₆ to C₃₀, such as C₆ to C₂₀) aryl, or C₅ to C₅₀ (such as C₆ to C₃₀, such as C₆ to C₂₀) substituted aryl group.

Alternately, in some embodiments of Formula (I), R¹, R², R³, and R⁴ are independently selected from methyl, ethyl, propyl, butyl, pentyl, neopentyl, adamantyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, phenyl, substituted phenyl (such as methylphenyl and dimethylphenyl), benzyl, substituted benzyl (such as methylbenzyl), naphthyl, cyclohexyl, cyclohexenyl, methylcyclohexyl, norbornyl, substituted norbornyl and isomers thereof.

In some embodiments of Formula (I), one or more of R¹ and R², R³ and R⁴, R¹ and Y, R³ and Y, R¹ and R³, and R¹ and R² and R³ are fused and may form saturated or aromatic cyclic or multicyclic groups.

In some embodiments of Formula (I), one or more of R¹, R², R³, and R⁴ comprises one or more catalyst compositions selected form the group consisting of catalyst compositions represented by the Formula (I).

In some embodiments of Formula (I), Y can be a linking group of formula —(CH₂)ₙ— wherein n=3−8, preferably n=4−6, preferably n=5.

In some embodiments of Formula (I), each Y is independently a hydrocarbyl group, or substituted hydrocarbyl group, a group containing 14, 15, 16, or 17 heteroatom, or a substituted group 13, 14, 15, 16, or 17 heteroatom (such as a silyl group, a substituted silyl group, oxygen group, sulfur group, nitrogen group or phosphine group) such as an alkyl, substituted alkyl, aryl, or substituted aryl group, such as a C₁ to C₅₀ (such as C₂ to C₃₀, such as C₃ to C₂₀) alkyl, C₁ to C₅₀ (such as C₂ to C₃₀, such as C₃ to C₂₀) substituted alkyl, C₅ to C₅₀ (such as C₆ to C₃₀, such as C₆ to C₂₀) aryl, or C₅ to C₅₀ (such as C₆ to C₃₀, such as C₆ to C₂₀) substituted aryl group.

Alternately, in some embodiments of Formula (I), each Y is independently selected from methylene, ethylene, propylene, butylene, pentylene, hexylene, heptylene, octylene, nonylene, decylene, undecylene, dodecylene, tridecylene, tetradecylene, pentadecylene, hexadecylene, heptadecylene, octadecylene, nonadecylene, eicosylene, heneicosylene, docosylene, tricosylene, tetracosylene, pentacosylene, hexacosylene, heptacosylene, octacosylene, nonacosylene, triacontylene, phenylene, substituted phenylene (such as 1,2-phenylene, 1,3-phenylene, 1,4-phenylene, 1,8-naphthalene, methylphenylene and dimethylphenylene), benzyl, substituted benzyl (such as methylbenzyl), naphthyl, cyclohexyl, cyclohexenyl, methylcyclohexyl, norbornyl, substituted norbornyl and isomers thereof.

In some embodiments of Formula (I), each Y is independently —O—, (—CH₂—)ₙ, where n is 1 to 50, alternately n is 2 to 30, alternately n is 3 to 12 (alternately n is 1, e.g., —CH₂—), —CR₂—, —SiR₂—, —GeR₂—, —NR-(where each R is independently methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, phenyl, substituted phenyl (such as methylphenyl and dimethylphenyl), benzyl, substituted benzyl (such as methylbenzyl), naphthyl, cyclohexyl, cyclohexenyl, methylcyclohexyl, norbornyl, or substituted norbornyl.

In some embodiments of Formula (I), Y is a bridging group containing at least one Group 13, 14, 15, 16, or 17 element, in particular boron or a Group 14, 15, 16, or 17 element. Examples of suitable bridging groups include P(═S)R*, P(═Se)R*, P(═O)R*, R*₂C, R*₂Si, R*₂Ge, R*₂CCR*₂, R*₂CCR*₂CR*₂, R*₂CCR*₂CR*₂CR*₂, R*C═CR*, R*C═CR*CR*₂, R*₂CCR*═CR*CR*₂, R*C═CR*CR*═CR*, R*C═CR*CR*₂CR*₂, R*₂CSiR*₂, R*₂SiSiR*₂, R*₂SiOSiR*₂, R*₂CSiR*₂CR*₂, R*₂SiCR*₂SiR*₂, R*C═CR*SiR*₂, R*₂CGeR*₂, R*₂GeGeR*₂, R*₂CGeR*₂CR*₂, R*₂GeCR*₂GeR*₂, R*₂SiGeR*₂, R*C═CR*GeR*₂, R*B, R*₂C—BR*, R*₂C—BR*—CR*₂, R*₂C—O—CR*₂, R*₂CR*₂C—O—CR*₂CR*₂, R*₂C—O—CR*₂CR*₂, R*₂C—O—CR*═CR*, R*₂C—S—CR*₂, R*₂CR*₂C—S—CR*₂CR*₂, R*₂C—S—CR*₂CR*₂, R*₂C—S—CR*═CR*, R*₂C—Se—CR*₂, R*₂CR*₂C—Se—CR*₂CR*₂, R*₂C—Se—CR*₂CR*₂, R*₂C—Se—CR*═CR*, R*₂C—N═CR*, R*₂C—NR*—CR*₂, R*₂C—NR*—CR*₂CR*₂, R*₂C—NR*—CR*═CR*, R*₂CR*₂C—NR*—CR*₂CR*₂, R*₂C—P═CR*, R*₂C—PR*—CR*₂, O, S, Se, Te, NR*, PR*, AsR*, SbR*, O—O, S—S, R*N—NR*, R*P—PR*, O—S, O—NR*, O—PR*, S—NR*, S—PR*, and R*N—PR* where R* is hydrogen or a C₁-C₂₀ containing hydrocarbyl, substituted hydrocarbyl, halocarbyl, substituted halocarbyl, silylcarbyl or germylcarbyl substituent and optionally two or more adjacent R* may join to form a substituted or unsubstituted, saturated, partially unsaturated or aromatic, cyclic or polycyclic substituent. Preferred examples for the bridging group Y include CH₂, CH₂CH₂, SiMe₂, SiPh₂, SiMePh, Si(CH₂)₃, Si(CH₂)₄, O, S, NPh, PPh, NMe, PMe, NEt, NPr, NBu, PEt, PPr, Me₂SiOSiMe₂, and PBu. In a preferred embodiment of the invention in any embodiment of any formula described herein, Y is represented by the formula ER^{y}₂ or (ER^{y}₂)₂, where E is C, Si, or Ge, and each R^{y} is, independently, hydrogen, halogen, C₁ to C₂₀ hydrocarbyl (such as methyl, ethyl, propyl, butyl, pentyl, hexyl, heptyl, octyl, nonyl, decyl, undecyl, or dodecyl) or a C₁ to C₂₀ substituted hydrocarbyl, and two R^{y} can form a cyclic structure including aromatic, partially saturated, or saturated cyclic or fused ring system. Preferably, Y is a bridging group comprising carbon or silicon, such as dialkylsilyl, preferably Y is selected from CH₂, CH₂CH₂, C(CH₃)₂, SiMe₂, Me₂Si—SiMe₂, cyclotrimethylenesilylene (Si(CH₂)₃), cyclopentamethylenesilylene (Si(CH₂)₅) and cyclotetramethylenesilylene (Si(CH₂)₄).

In some embodiments of Formula (I), X is a mono- or multi-anionic (such as tri-anionic) group that acts as an initiator for the polymerization. Alternately, each X is independently a halide, an alkoxide, aryloxide, a carboxylate, a carbonate, a sulfate, a phosphate, di-alkoxide, di-aryloxide, a di-carboxylate, a di-carbonate, a di-sulfate, a di-phosphate (such as a di-carboxylate) or tri-alkoxide, tri-aryloxide, a tri-carboxylate, a tri-carbonate, a tri-sulfate, a tri-phosphate (such as a tri-carboxylate), or a combination thereof. Alternately, each X is independently a dicarboxylate (such as Norbornene di-carboxylate). Additionally, X can contain one or more than one alcohol groups (—OH) and thiol groups (—SH). X can contain a group 13 to 17 heteroatom, such as B, Si, Ge, Sn, N, P, As, O, S, Se, Te, or the aforementioned elements with hydrogens attached, such as BH, BH₂, SiH₂, OH, NH, NH₂, etc. X can be a substituted heteroatom, e.g., a heteroatom that has one or more of these hydrogen atoms replaced by a hydrocarbyl or substituted hydrocarbyl group(s). X can be a substituted group 13 to 16 heteroatom, such as —O(R*), —OS(O)₂(R*), —OS(O)₂CF₃, —S(R*), —N(R*)₂, —NH(R*), —P(R*)₂, —PH(R*), —Si(R*)₃, —SiH(R*)₂, —SiH₂(R*), —Ge(R*)₃, —B(R*)₂, —BH(R*) wherein R* is hydrocarbyl or substituted hydrocarbyl, such as, but not limited to, arylalkyl, alkylaryl, alkenyl, alkynyl, cycloalkyl, and the like, and wherein two or more adjacent R* may join together to form a cyclic or polycyclic structure.

For Complex 1, R¹ and R² formed a fused ring with boron namely 9-Borabicyclo(3.3.1)nonane, R³═R⁴=cyclohexyl, Y=pentamethylene, X═Br.

For Complex 2, R¹ and R² formed a fused ring with boron namely 9-Borabicyclo(3.3.1)nonane, R³═R⁴=tert-butyl, Y=pentamethylene, X═Br.

For Complex 3, R¹═R²=cyclohexyl, R³═R⁴=tert-butyl, Y=pentamethylene, X═Br.

For Complex 4, R¹ and R² formed a fused ring with boron namely 9-Borabicyclo(3.3.1)nonane, R³ and R⁴ formed a fused ring with phosphine namely 9-phosphabicyclo(3.3.1)nonane, Y=pentamethylene, X═Br.

For Complex 5, R¹ and R² formed a fused ring with boron namely 9-Borabicyclo(3.3.1)nonane, R³═R⁴=1-adamantyl. Y=pentamethylene, X═Br.

Specific examples of catalyst complexes useful herein are shown below:

| | |
|---|---|
| 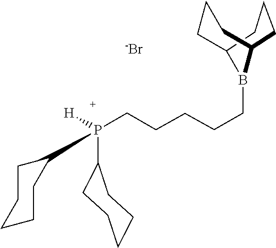 | Complex 1 |
| 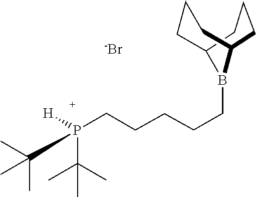 | Complex 2 |
| 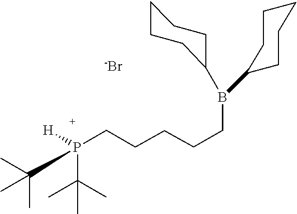 | Complex 3 |
| 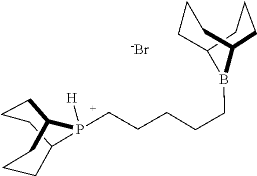 | Complex 4 |
| 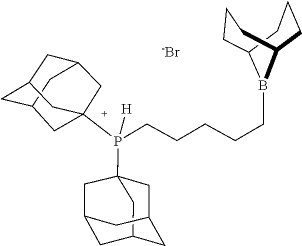 | Complex 5 |
| 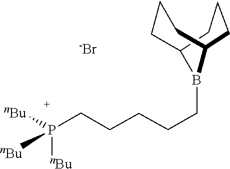 | Complex 6 |
| (quaternary phosphonium comparative) | |

Additional catalyst complexes useful herein are shown below:

| | |
|---|---|
| 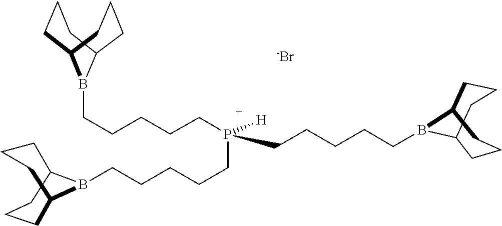 | Complex 7 |
| 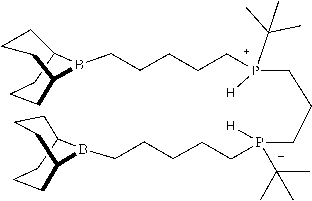 | Complex 8 |
| 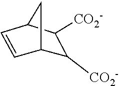 | |
| 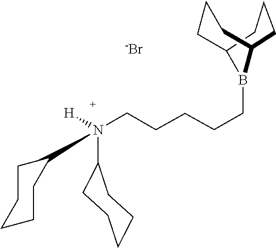 | Complex 9 |
| 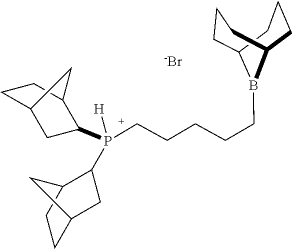 | Complex 10 |
| 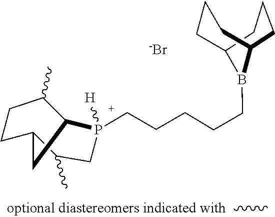 | Complex 11 |
| 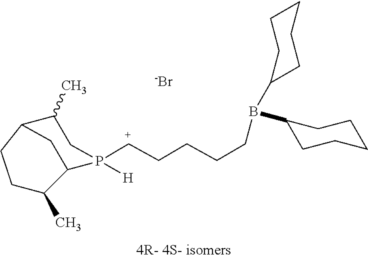 | Complex 12 |
| 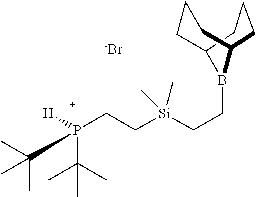 | Complex 13 |
| 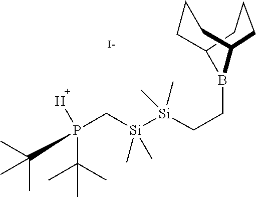 | Complex 14 |
| 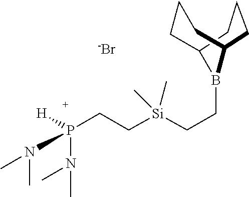 | Complex 15 |
| 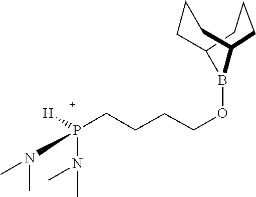 | Complex 16 |
| 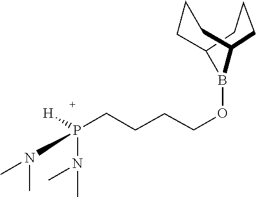 | |
| 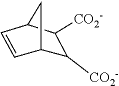 | |
| 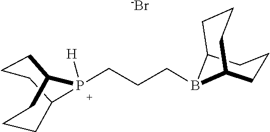 | Complex 17 |
| 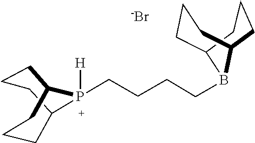 | Complex 18 |
| 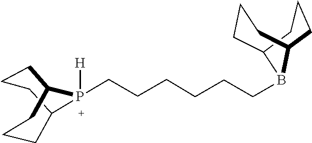 | Complex 19 |
| 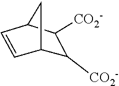 | |
| 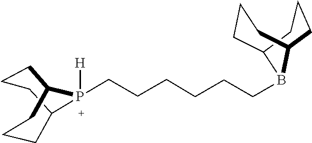 | |
| 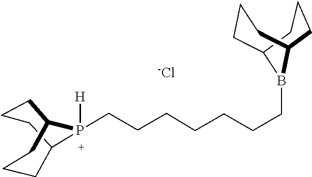 | Complex 20 |
| 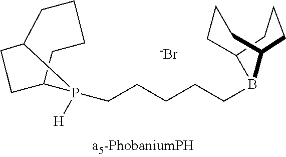 | Complex 21 |
| 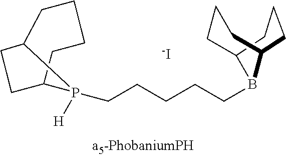 | Complex 22 |
| 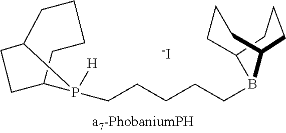 | Complex 23 |
| 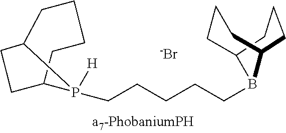 | Complex 24 |
| 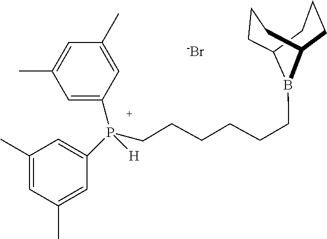 | Complex 25 |
| 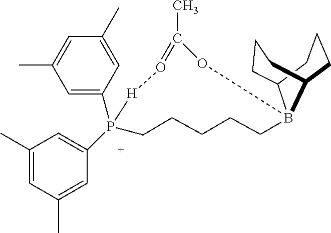 | Complex 26 |
| 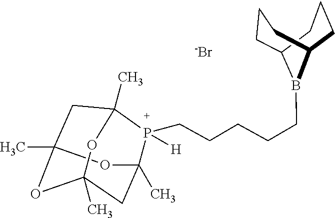 | Complex 27 |
| 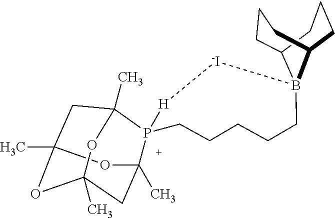 | Complex 28 |
| 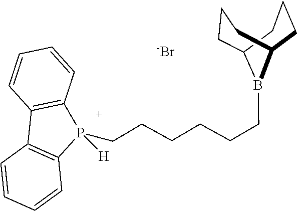 | Complex 29 |
| 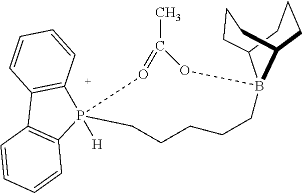 | Complex 30 |
| 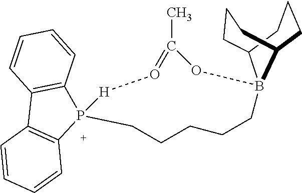 | Complex 31 |
| 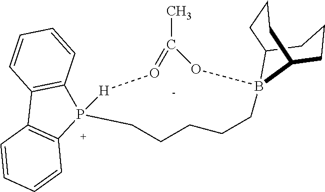 | Complex 32 |

Catalyst compounds that are particularly useful in this invention include one or more of Complex 2 named as “(5-(9-borabicyclo[3.3.1]nonan-9-yl)pentyl)di-tert-butylphosphonium bromide”, Complex 4 named as “9-(5-(9-borabicyclo[3.3.1]nonan-9-yl)pentyl)-9-phosphabicyclo[3.3.1]nonan-9-ium bromide”, Complex 5 named as “(5-9 borabicyclo[3.3.1]nonan-9-yl)pentyl)di(adamantan-1-yl)phosphonium bromide” are particularly of interest.

In alternate embodiments in any of the processes described herein one pnictogenium-borane catalyst complex is used, e.g. the catalyst complexes are not different. For purposes of this invention one catalyst complex is considered different from another if they differ by at least one atom.

In some embodiments, two or more different catalyst complexes are present in the catalyst system used herein. In some embodiments, two or more different catalyst complexes are present in the reaction zone where the process(es) described herein occur. It is optional to use the same initiator for the compounds, however, two different initiators can be used in combination.

The two catalyst complexes may be used in any ratio. Preferred molar ratios of (A) catalyst complex to (B) catalyst complex fall within the range of (A:B) 1:1000 to 1000:1, alternatively 1:100 to 500:1, alternatively 1:10 to 200:1, alternatively 1:1 to 100:1, and alternatively 1:1 to 75:1, and alternatively 5:1 to 50:1. The particular ratio chosen will depend on the exact complex chosen, the method of initiation, and the end product desired. In a particular embodiment, when using the two catalysts, useful mole percents, based upon the molecular weight of the catalysts, are 10% to 99.9% A to 0.1% to 90% B, alternatively 25% to 99% A to 0.5% to 50% B, alternatively 50% to 99% A to 1% to 25% B, and alternatively 75% to 99% A to 1% to 10% B.

### General Methods to Prepare the Tertiary Pnictogenium-Borane Catalyst Compounds.

Secondary pnictogen is allowed to react with alkenyl bromide (or halide) in acetonitrile (MeCN) at 25° C.-85° C. for 24-96 hours to afford pnictogenium bromide (or halide) as the product. The pnictogenium bromide (or halide) is then allow to react with dialkyl hydrido borane in THF or dichloromethane at 20° C.-65° C. for 24-96 hours, affording the catalyst complex.

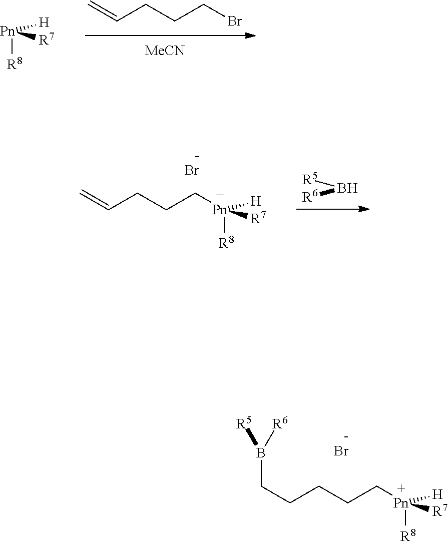

### Initiators

In any embodiment of Formula (I), X is a mono- or multi-anionic (such as tri-anionic) group that acts as an initiator for the polymerization. Alternately, each X is independently a halide, alkoxide, carboxylate, sulfate, triflate, phosphate, di-alkoxide, di-aryloxide, a di-carboxylate, a di-carbonate, a di-sulfate, a di-phosphate (such as a di-carboxylate), or tri-alkoxide, tri-aryloxide, a tri-carboxylate, a ti-carbonate, a ti-sulfate, a tri-phosphate (such as a tri-carboxylate), or a combination thereof

### Examples of Mono-Anionic Initiators:

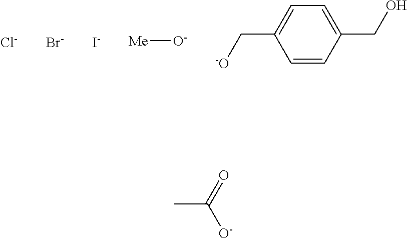

### Examples of Multi-Anionic Initiators:

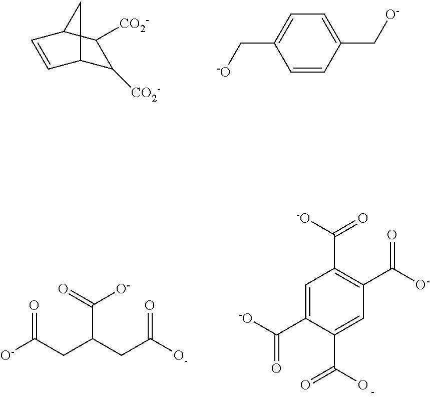

### Chain-Transfer Agents

In general, chain-transfer-agents (CTAs) allow the polymerization to produce additional polymer chains. CTAs can be used to produce additional polymer chains. CTA's can also be used to control the molecular weights. CTAs useful with the catalyst complexes can include water, alcohols (such as di-alcohols), carboxylic acids (such as dicarboxylic acids), carboxylates, or thio groups. Examples include: water, ethanol, methanol, 1,4-benzenedimethanol, 1,2-trans-dihydroxycyclohexane, and terephthalic acid. CTAs can also be an oligomer or a polymer featuring one or more than one alcohol or carboxylic acid end groups.

In embodiments, bifunctional chain-transfer agents (such as polyols) can be used with the catalyst complexes described herein to produce additional telechelic polymers with multiple functional groups (such as poly-ols). Useful bifunctional chain transfer agents include 1,4-benzenedimethanol, 1,2-trans-dihydroxycyclohexane, terephthalic acid, or telechelic polyols.

### Examples of Chain-Transfer-Agents (CTAs):

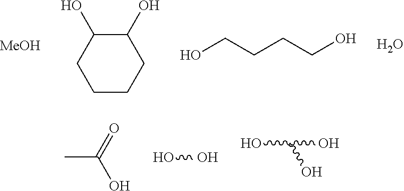

where [symbol]
represents oligomers or polymers containing one or more OH groups

### Co-Activators

Co-activators may be used with the catalyst complexes. A co-activator is usually a Lewis acid or a Lewis base that, by itself, does not catalyze the polymerization of CO₂/epoxide or lactone or lactide. A co-activator, may be used in conjunction with an initiator in order to form an active catalyst complex. In some embodiments a co-activator can be pre-mixed with the catalyst complex before introduction into a reaction zone or may be introduced separately into the reaction zone. Compounds which may be utilized as co-activators include, for example, phosphonium halide and bis(triphenylphosphine)iminium halide, or triethyl borane, tricyclohexyl borane, tri-n-hexyl borane, 1,8-Diazabicyclo[5.4.0]undec-7-ene, etc.

### Polymerization Processes

In embodiments herein, the invention relates to polymerization processes where one or more epoxide monomers and one or more of CO₂, COS, CS₂, are contacted with one or more catalyst compositions as described above, to form oxygen containing polymers, such as polyalkylene carbonates, polyalkylene ether carbonates, or polyether.

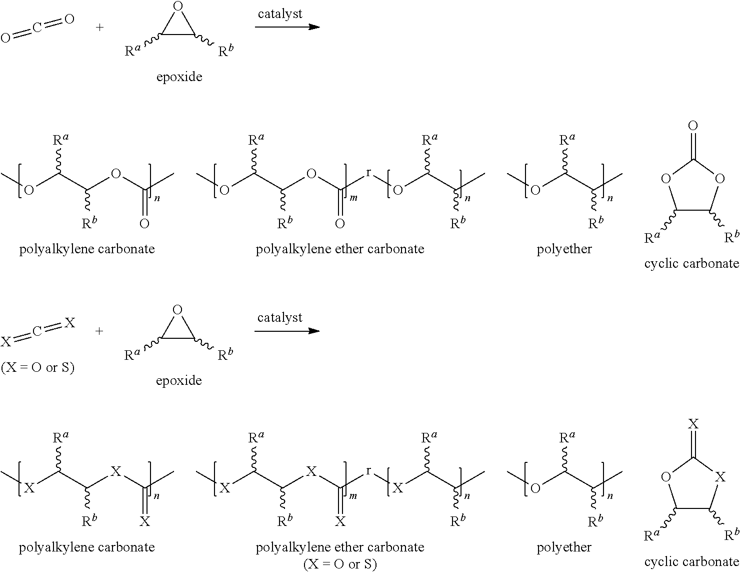

In embodiments herein, the invention relates to polymerization processes where carbon dioxide is copolymerized with vinyl cyclohexene dioxide or limonene dioxide to form polyalkylene carbonate polymers comprising pendant cyclic carbonate groups as shown below.

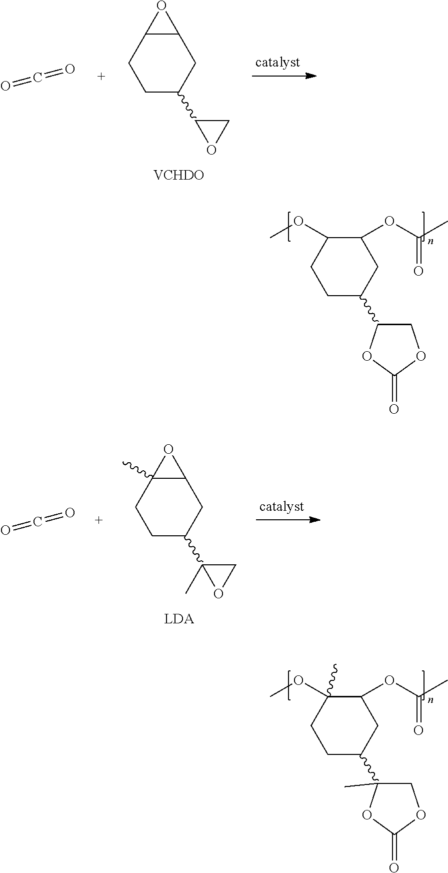

In embodiments herein, the invention relates to polymerization processes where one or more epoxide monomers and one or more of cyclic anhydrides, are contacted with one or more catalyst compositions as described above, to form to form poly(epoxide)(cyclic anhydride), poly(epoxide)(cyclic anhydride) ether, or polyether.

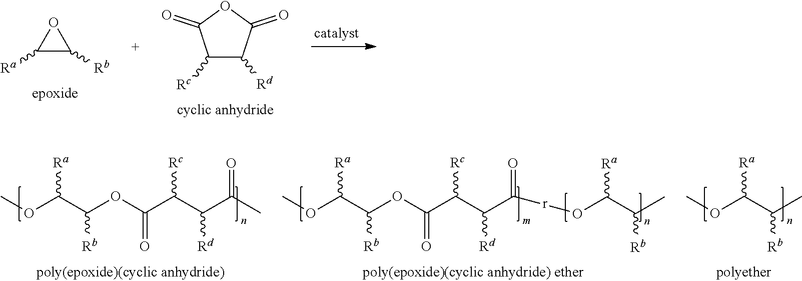

In embodiments herein, the invention relates to polymerization processes where one or more lactone or lactide monomers and, are contacted with catalyst compounds as described above, to form polylactone polymers, such as polycaprolactone, polydecalactone, polymethylcaprolactone, polylactide, or copolymers thereof.

In embodiments herein, the invention relates to polymerization processes where one or more lactone monomers and, optionally, one or more caprolactone monomers are contacted with one or more catalyst compounds as described above, to form polylactone polymers, such as polycaprolactone, polydecalactone, polymethylcaprolactone, or copolymers thereof and thereafter said polymer is contacted with one or more epoxide monomers, one or more of CO₂, COS, CS₂, cyclic anhydrides and one or more catalyst compositions as described above, to form copolymers, such as random copolymers, gradient copolymers, or block copolymers.

An embodiment of the present technological advancement relates to a method to produce polymers comprising: contacting a catalyst composition represented by the Formula (I) with one or more caprolactones, to obtain polycaprolactones.

Epoxide monomers useful herein include epoxides, substituted epoxides, and isomers thereof. Examples of epoxides include, but are not limited to, cyclohexene oxide, methyl cyclohexene oxide, dimethyl cyclohexene oxide, ethyl cyclohexene oxide, vinyl cyclohexene oxide, vinyl cyclohexene dioxide, limonene oxide, limonene dioxide, ethylene oxide, propylene oxide, butylene oxide, isobutylene oxide, pentene oxide, hexene oxide, heptane oxide, octene oxide, epichlorohydrin, glycidyl methyl ether, glycidyl ethyl ether, glycidyl n-butyl ether, glycidyl isobutyl ether, glycidyl allyl ether, glycidyl 2-ethylhexyl ether, glycidyl benzyl ether, glycidyl phenyl ether, norbornene oxide.

Cyclic anhydride monomers useful herein include succinic anhydride, maleic anhydride, methyl succinic anhydride, citraconic anhydride, phenyl succinic anhydride, glutaric anhydride, diglycolic anhydride, pimelic anhydride, phthalic anhydride, cyclohexene anhydride, cyclohexane anhydride, cyclopentane anhydride, carbic anhydride.

Exemplary epoxide monomers include cyclohexene oxide and vinyl cyclohexene oxide and their respective homologs and derivatives.

In embodiments of the invention, the epoxide monomer (such as cyclohexene oxide and vinyl cyclohexene oxide) is combined with one or more of CO₂, COS, CS₂, such as CO₂.

Lactone monomers include lactones and substituted lactones such as methyl caprolactone and decalactone. Lactone comprises caprolactone.

Lactones are cyclic carboxylic esters, containing a 1-oxacycloalkan-2-one structure (—C(═O)—O—), “substituted lactones” are lactones that have one or more hydrogen groups replaced by hydrocarbyl, substituted hydrocarbyl, heteroatom or heteroatom containing group and or have one or more ring atoms replaced by a heteroatom.

Lactone monomers useful herein include caprolactone, substituted caprolactone (such as alkyl-caprolactone, where the alkyl is a C₁ to C₃₀ alkyl), such as methyl-caprolactone), valerolactone, propiolactone, butyrolactone, hexalactone, decalactone.

Monomers and comonomers used herein may be linear, branched, or cyclic, and if cyclic may be strained or unstrained, monocyclic or polycyclic, and may optionally include heteroatoms and/or one or more functional groups.

### Polymerization

A solution polymerization is a polymerization process in which the polymer is dissolved in a liquid polymerization medium, such as an inert solvent or monomer(s) or their blends. A solution polymerization is typically homogeneous. A homogeneous polymerization is one where polymer product is dissolved in the polymerization medium, such as 80 wt % or more, 90 wt % or more or 100% of polymer product is dissolved in the reaction medium. Such systems are preferably not turbid as described in Oliveira, J. V. C. et al. (2000), Ind. Eng. Chem. Res., v.29, pg. 4627.

A bulk polymerization means a polymerization process in which the monomers and/or comonomers being polymerized are used as a solvent or diluent using little or no inert solvent as a solvent or diluent. A small fraction of inert solvent might be used as a carrier for catalyst and scavenger. A bulk polymerization system typically contains less than 25 wt % of inert solvent or diluent, preferably less than 10 wt %, preferably less than 1 wt %, preferably 0 wt %.

Polymerization processes of this invention can be carried out in any manner known in the art. Any suspension, homogeneous, bulk, or solution polymerization process known in the art can be used. Such processes can be run in a batch, semi-batch, or continuous mode. Homogeneous polymerization processes are typically useful, such as homogeneous polymerization process where at least 90 wt % of the product is soluble in the reaction media.) A bulk homogeneous process is also useful, such as a process where monomer concentration in all feeds to the reactor is 70 volume % or more. Alternately, no solvent or diluent is present or added in the reaction medium, (except for the small amounts used as the carrier for the catalyst system or other additives, or amounts typically found with the monomer.).

Suitable diluents/solvents for polymerization include inert liquids. Examples include straight and branched-chain hydrocarbons, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof, such as can be found commercially (Isopar™ fluids); perhalogenated hydrocarbons, such as perfluorinated C₄₋₁₀ alkanes, chlorobenzene, and aromatic and alkylsubstituted aromatic compounds, such as benzene, toluene, mesitylene, and xylene. Suitable solvents also include liquid olefins which may act as monomers or comonomers including ethylene, propylene, 1-butene, 1-hexene, 1-pentene, 3-methyl-1-pentene, 4-methyl-1-pentene, 1-octene, 1-decene, and mixtures thereof. In a preferred embodiment, aliphatic hydrocarbon solvents are used as the solvent, such as isobutane, butane, pentane, isopentane, hexanes, isohexane, heptane, octane, dodecane, and mixtures thereof, cyclic and alicyclic hydrocarbons, such as cyclohexane, cycloheptane, methylcyclohexane, methylcycloheptane, and mixtures thereof. In another embodiment, the solvent is not aromatic, preferably aromatics are present in the solvent at less than 1 wt %, preferably less than 0.5 wt %, preferably less than 0 wt % based upon the weight of the solvents. Suitable diluents/solvents for polymerization also include polar, hetero-atom containing liquids such as tetrahydrofuran, dichloromethane, dimethoxyethane.

In a preferred embodiment, the feed concentration of the monomers and comonomers for the polymerization is 60 vol % solvent or less, preferably 40 vol % or less, or preferably 20 vol % or less, based on the total volume of the feedstream, or preferably no solvent. Preferably the polymerization is run in a bulk process.

Preferred polymerizations can be run at any temperature and/or pressure suitable to obtain the desired polymers. Typical temperatures and/or pressures include a temperature in the range of from about 0° C. to about 300° C., preferably about 20° C. to about 200° C., preferably about 35° C. to about 150° C., preferably from about 40° C. to about 130° C., preferably from about 45° C. to about 120° C.; and at a pressure in the range of from about 0.35 MPa to about 10 MPa, preferably from about 0.45 MPa to about 6 MPa, or preferably from about 0.5 MPa to about 4 MPa.

In a typical polymerization, the run time of the reaction is up to 4,320 minutes, preferably in the range of from about 3 to 1,440 minutes, or preferably from about 10 to 240 minutes.

In an alternate embodiment, the activity of the catalyst is at least 50 g/g of cat, preferably 500 or more g/g of cat, preferably 5,000 or more g/g of cat, preferably 50,000 or more g/g of cat. In an alternate embodiment, the conversion of monomer is at least 5%, based upon polymer yield and the weight of the monomer entering the reaction zone, preferably 10% or more, preferably 30% or more, preferably 50% or more, preferably 80% or more.

Sequential monomer addition polymerization allows the synthesis of multi-block copolymers that can be used in adhesives, elastomers, and thermoplastics, among other things.

In alternate embodiments, the catalyst complexes described herein may be used to prepare block copolymers, typically diblock and triblock copolymers. This may done by sequential monomer addition to the same catalyst complexes or by sequential polymerization reactions with different catalysts. This may also done by sequential monomer addition to multiple catalyst complexes or addition of new catalyst complexes and monomer in the same or different reaction zones.

In alternate embodiments, the catalyst complex as described herein can be used in combination with a non-pnictogen-borane catalyst, such as a metal catalyst compound (such as tin 2-ethylhexanoate), to produce block copolymers. For example such metal catalyst compounds can produce telechelic poly-ols of polylactones (such as polycaprolactone) in the first stage of polymerization. The catalysts can then be introduced at the second stage polymerization which enables the copolymerization with epoxides/CO₂, COS, CS₂. The epoxide can be introduced at either the first or second stage.

In a preferred embodiment, a polymerization reaction for catalyst composition represented by Formula (I):
1) is conducted at temperatures of 0° C. to 300° C. (preferably 20° C. to 200° C., preferably 35° C. to 150° C., preferably 40° C. to 130° C.);
2) is conducted at a pressure of atmospheric pressure to 10 MPa (preferably 0.35 to 10 MPa, preferably from 0.45 to 6 MPa, preferably from 0.5 to 4 MPa);
3) is conducted in solvent, or may be conducted in neat epoxides (without or with added solvents such as dichloromethane or toluene;
4) the polymerization reaction is preferred to be formed under an inert atmosphere such as nitrogen or argon;
5) occurs in one reaction zone; and
6) has a turnover number for the catalyst composition of 100 or more, (preferably at least 200, preferably at least 500, preferably at least 5,000).

In a preferred embodiment, the catalyst composition used in the polymerization comprises no more than one catalyst complex. A “reaction zone” also referred to as a “polymerization zone” is a vessel where polymerization takes place, for example a batch reactor. When multiple reactors are used in either series or parallel configuration, each reactor is considered as a separate polymerization zone. For a multi-stage polymerization in both a batch reactor and a continuous reactor, each polymerization stage is considered as a separate polymerization zone. In a preferred embodiment, the polymerization occurs in one reaction zone. Room temperature is 23° C. unless otherwise noted.

Other additives may also be used in the polymerization, as desired, such as one or more scavengers, promoters, modifiers, reducing agents, oxidizing agents, hydrogen, aluminum alkyls, silanes, or chain transfer agents.

### Polymer Properties

Typically, the polymers produced herein have an Mw of 500 to 3,000,000 g/mol (preferably 1,000 to 750,000 g/mol, preferably 10,000 to 500,000 g/mol) as determined by LT THF GPC-1D (see procedure below).

Typically, the polymers produced herein have an Mw/Mn of greater than 1 to 40 (alternately 1.01 to 20, alternately 1.1 to 10, alternately 1.3 to 5, 1.4 to 4, alternately 1.5 to 3), as determined by the GPC methods.

In a preferred process the polymerization catalysts described herein are used to produce polycarbonate block copolymers.

### Blends and End Uses

In another embodiment, the polymer produced herein is combined with one or more additional polymers prior to being formed into an article. Other useful polymers include polyethylene, isotactic polypropylene, highly isotactic polypropylene, syndiotactic polypropylene, random copolymer of propylene and ethylene, and/or butene, and/or hexene, polybutene, ethylene vinyl acetate, LDPE, LLDPE, HDPE, ethylene vinyl acetate, ethylene methyl acrylate, copolymers of acrylic acid, polymethylmethacrylate or any other polymers polymerizable by a high-pressure free radical process, polyvinylchloride, polybutene-1, isotactic polybutene, ABS resins, ethylene-propylene rubber (EPR), vulcanized EPR, EPDM, block copolymer, styrenic block copolymers, polyamides, polycarbonates, PET resins, cross linked polyethylene, copolymers of ethylene and vinyl alcohol (EVOH), polymers of aromatic monomers such as polystyrene, poly-1 esters, polyacetal, polyvinylidine fluoride, polyethylene glycols, and/or polyisobutylene.

In a preferred embodiment, the polymer is present in the above blends, at from 10 wt % to 99 wt %, based upon the weight of the polymers in the blend, preferably 20 wt % to 95 wt %, even more preferably at least 30 wt % to 90 wt %, even more preferably at least 40 wt % to 90 wt %, even more preferably at least 50 wt % to 90 wt %, even more preferably at least 60 wt % to 90 wt %, even more preferably at least 70 wt % to 90 wt %.

The blends described above may be produced by mixing the polymers of the invention with one or more polymers (as described above), by connecting reactors together in series to make reactor blends or by using more than one catalyst in the same reactor to produce multiple species of polymer. The polymers can be mixed together prior to being put into the extruder or may be mixed in an extruder.

The blends may be formed using conventional equipment and methods, such as by dry blending the individual components and subsequently melt mixing in a mixer, or by mixing the components together directly in a mixer, such as, for example, a Banbury mixer, a Haake mixer, a Brabender internal mixer, or a single or twin-screw extruder, which may include a compounding extruder and a side-arm extruder used directly downstream of a polymerization process, which may include blending powders or pellets of the resins at the hopper of the film extruder. Additionally, additives may be included in the blend, in one or more components of the blend, and/or in a product formed from the blend, such as a film, as desired. Such additives are well known in the art, and can include, for example: fillers; antioxidants (e.g., hindered phenolics such as IRGANOX™ 1010 or IRGANOX™ 1076 available from Ciba-Geigy); phosphites (e.g., IRGAFOS™ 168 available from Ciba-Geigy); anti-cling additives; tackifiers, such as polybutenes, terpene resins, aliphatic and aromatic hydrocarbon resins, alkali metal and glycerol stearates, and hydrogenated rosins; UV stabilizers; heat stabilizers; anti-blocking agents; release agents; anti-static agents; pigments; colorants; dyes; waxes; silica; fillers; talc; and the like.

Any of the foregoing polymers and compositions in combination with optional additives (anti-oxidants, colorants, dyes, stabilizers, filler, etc.) may be used in a variety of end-use applications produced by methods known in the art. Exemplary end uses are as articles formed by molding techniques, e.g., injection or blow molding, extrusion coating, foaming, casting, and combinations thereof.

### EXPERIMENTAL

### GPC Method

The equipment used is as follows:
Agilent 1260 Infinity II Multi-Detector GPC/SEC System;
Pump—Quaternary Pump (up to four different solvents);
Operation temperature range: 30° C.-60° C.; and

### Detectors:

Differential Refractive Index (DRI) detector at 658 nm,
Viscometer detector (Inlet Pressure and Differential Pressure),
Light Scattering (LS) detector at 658 nm (dual channel MALS: 90° and 15°), and
UV Diode Array Detector (Up to eight wavelengths from 190-950 nm).

All detectors were plumbed in series: UV to Light Scattering to Refractive Index to Viscometer.

Agilent Multi-Detector GPC/SEC Instrument control and Data Analysis Software Suite was used.

The chromatographic conditions were as follows:
Column: 2×PLgel 5 m Mixed-C, 7.5×300 mm with a Guard column;
Eluent: Tetrahydrofuran (stabilized with 250 ppm BHT);
Operation temperature: 40° C.;
Injection volume: 25 μL;
Run flow rate: 1.0 mL/min; and
Run time: 36 minutes with 3-minute post run time.

The detectors calibration was performed by using a traceable 50,000 g/mole polystyrene narrow standard. The column calibration was performed by using twenty-three traceable polystyrene narrow standards range from 200 g/mole to 4,000,000 g/mole.

### Materials

Cyclohexene oxide (CHO), butylene oxide (BO), propylene oxide (PO), dicholoromethane (DCM), caprolactone (CL), and decalactone (DL) were purchased from Aldrich, and purified by distilling over CaH₂ under N₂. Phenylene dimethanol (PDM) and trans-1,2-dihydroxycyclohexane (DHCH) were purchased from Aldrich and recrystallized from anhydrous toluene. Methyl caprolactone (MCL) were synthesized according to literature procedures (Macromolecules 2011, v.44, pp. 8537-8545). 9-phosphabicyclononane (isomers) commonly referred to as phobanes was purchased from Strem. Phobane isomers may be separated prior to use as described in J. Am. Chem. Soc. 2009, v.131, pp 3078-3092. 4,8-dimethyl-2-phosabicyclo[3.3.1]nonane (isomers) lim-PH was purchased from Strem.

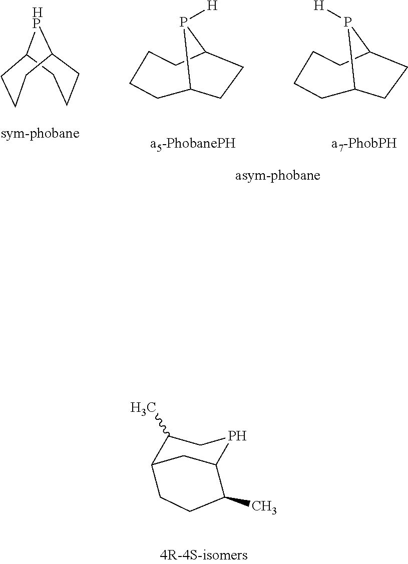

Phobane[3.3.1] Phobane [4.2.1]

### Examples

### Synthesis: 9-(pent-4-en-1-yl)-9-phosphabicyclo[3.3.1]nonan-9-ium bromide

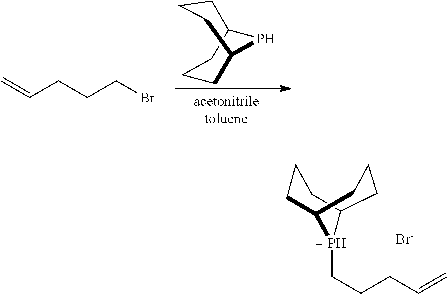

9-(pent-4-en-1-yl)-9-phosphabicyclo[3.3.1]nonan-9-ium bromide (C₁₃H₂₄BrP). A toluene solution (60 wt %) of 9-phosphabicyclo[3.3.1]nonane (5.00 g, 21.1 mmol, two isomers), purchased from Strem, was combined with 5-bromopent-1-ene (3.14 g, 21.1 mmol) in 20 ml of acetonitrile. The solution was heated to 85° C. for 16 hours. The solvent was removed and the solids were triturated with several 10 ml portions of hexane until a white powder was obtained. The solid was dried under vacuum. The product was isolated as a white solid (5.00 g, 81.4%). ¹H NMR (400 MHz, CD₂Cl₂) δ 7.65 (d, 1H, J_{PH}=522 Hz), 7.55 (d, 1H, J_{PH}=490 Hz, lesser isomer), 5.92-5.79 (m, 1H), 5.22-5.07 (m, 2H), 3.49 (br, 1H, lesser isomer), 2.88 (d, J=16.4 Hz, 1H), 2.75-1.37 (m, 19H). ¹³C NMR (126 MHz, CDCl₃) δ 126.57 (d, J=2397.9 Hz), 126.58 (d, J=2358.2 Hz), 34.19 (d, J=15.1 Hz), 30.26 (d, J=42.2 Hz), 29.76 (d, J=2.8 Hz), 29.51 (d, J=3.7 Hz), 28.54 (d, J=12.5 Hz), 25.51 (d, J=3.7 Hz), 24.74 (d, J=2.7 Hz), 23.81 (d, J=4.5 Hz), 21.75 (d, J=4.0 Hz), 21.21 (d, J=42.0 Hz), 20.95 (d, J=7.6 Hz), 20.31 (d, J=6.8 Hz), 15.62 (d, J=37.2 Hz), 15.01 (d, J=44.3 Hz). ³¹P NMR (162 MHz, CDCl₃) δ 31.88 (lesser isomer), 10.23.

### Synthesis: 9-(5-(9-borabicyclo[3.3.1]nonan-9-yl)pentyl)-9-phosphabicyclo[3.3.1]nonan-9-ium bromide

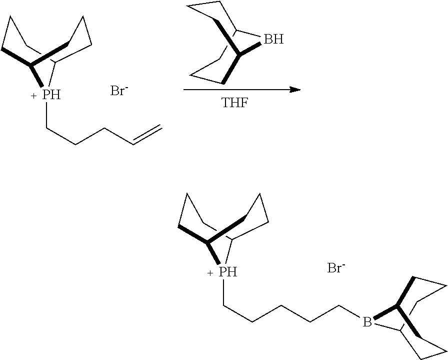

9-(5-(9-borabicyclo[3.3.1]nonan-9-yl)pentyl)-9-phosphabicyclo[3.3.1]nonan-9-ium bromide (C₂₁H₃₉BBrP). 9-(pent-4-en-1-yl)-9-phosphabicyclo[3.3.1]nonan-9-ium bromide (3.20 g, 11.0 mmol) was mixed in a dichloromethane (15 ml) solution of 9-BBN (2.00 g, 16.4 mmol). The mixture was stirred for 16 hours at room temperature. The solution was concentrated to approximately 1 ml and 20 ml of pentane was added precipitating a white powder (1.00 g, 22%, one isomer). ¹H NMR (400 MHz, CD₂Cl₂) δ 7.58 (d, J_{PH}=509.3 Hz, 1H), 2.87 (d, J=16.2 Hz, 2H), 2.70-1.12 (m, 36H). ¹³C NMR (126 MHz, CDCl₃) δ 33.75 (d, J=14.1 Hz), 33.11, 31.01, 29.56 (d, J=3.7 Hz), 27.66, 25.53 (d, J=3.7 Hz), 23.92, 23.16, 22.47 (d, J=4.5 Hz), 21.20 (d, J=41.9 Hz), 20.65 (dd, J=81.2, 7.1 Hz), 15.64 (d, J=43.3 Hz). ³¹P NMR (162 MHz, CD₂Cl₂) δ 10.43. ¹¹B NMR (128 MHz, CDCl₃) δ 87.89.

### Synthesis: Di-tert-butyl(pent-4-en-1-yl)phosphonium bromide

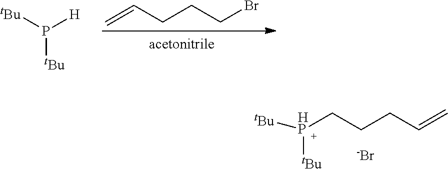

Di-tert-butyl(pent-4-en-1-yl)phosphonium bromide (C₁₃H₂₈BrP). Di-tert-butylphosphine (4.5 g, 30.8 mmol) and 5-Bromo-1-pentene (4.59 g, 30.8 mmol) in acetonitrile (10 ml) were combined and stirred at 90° C. for 24 hours. The solvent was then removed under vacuo. The solid was rinsed with several pentane (˜10 ml) washings. The product was isolated as white solid (5.4 g, 59.4%). ¹H NMR (400 MHz, CDCl₃) δ 8.73 (d, J_{PH}=487.1 Hz, 1H), 5.73-5.63 (m, 1H), 5.21-4.93 (m, 2H), 2.22 (d, J=6.7 Hz, 2H), 2.15-1.75 (m, 4H), 1.50 (d, J=16.0 Hz, 18H). ¹³C NMR (126 MHz, CDCl₃) δ 135.70, 117.63, 34.54 (d, J=13.1 Hz), 32.83 (d, J=34.5 Hz), 27.57, 25.27 (d, J=4.9 Hz), 14.05 (d, J=39.6 Hz). ³¹P NMR (202 MHz, CDCl₃) δ 32.47.

### Synthesis: (5-(9-borabicyclo[3.3.1]nonan-9-yl)pentyl)di-tert-butylphosphonium bromide

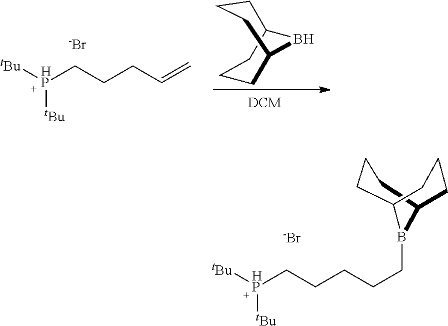

(5-(9-borabicyclo[3.3.1]nonan-9-yl)pentyl)di-tert-butylphosphonium bromide (C₂₁H₄₃BrPB). Mix di-tert-butyl(pent-4-en-1-yl)phosphonium bromide (3.00 g, 10.2 mmol) and 9-BBN (1.30 g, 10.7 mmol) in dichloromethane (80 ml) and stir at 40° C. for 16 hours. All solvent was then removed under vacuo. The crude product was stirred in pentane (20 ml) for 30 minutes. The pure product (4.24 g, 100%) was obtained by filtration as white solid and was washed by pentane. ¹H NMR (500 MHz, CDCl₃) δ 8.80 (d, J_{PH}=489.3 Hz, 1H), 2.19-2.07 (m, 2H), 2.10-1.90 (m, 2H), 1.91-1.75 (m, 6H), 1.75-1.46 (m, 28H), 1.38 (t, J=7.1 Hz, 2H), 1.26-1.14 (m, 2H). ¹³C NMR (126 MHz, CDCl₃) δ 34.36 (d, J=12.4 Hz), 33.10, 32.75 (d, J=34.5 Hz), 30.99, 27.62, 26.16 (d, J=5.3 Hz), 23.70, 23.15, 15.31, 15.01. ³¹P NMR (162 MHz, CDCl₃) δ 32.34. ¹¹B NMR (128 MHz, CDCl₃) δ 87.65.

### Synthesis: Di-tert-butyl(5-(dicyclohexylboraneyl)pentyl)phosphonium bromide

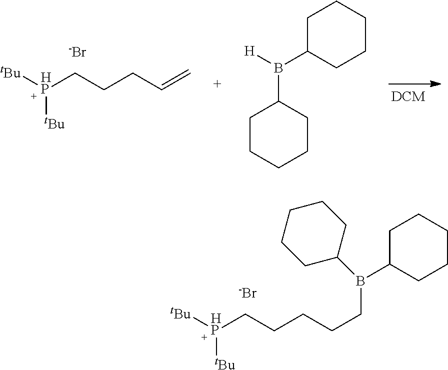

Di-tert-butyl(5-(dicyclohexylboraneyl)pentyl)phosphonium bromide (C₂₅H₅₁BrPB). To a dichloromethane (4.0 ml) solution of di-tert-butyl(pent-4-en-1-yl)phosphonium bromide (0.50 g, 1.69 mmol), solid dicyclohexylborane (0.30 g, 1.69 mmol) was added under −20° C. 3 ml of THF was added and the reaction was stirred for 16 hours at room temperature. All solvents were then removed under vacuo. The crude product was stirred in pentane (4 ml) for 30 minutes. The pure product (0.57 g, 71%) was obtained by filtration as white solid and was washed by pentane and diethyl ether. ¹H NMR (500 MHz, CDCl₃) δ 8.65 (d, J_{PH}=486 Hz, 1H), 2.16-2.05 (m, 2H), 1.91 (h, J=8.1 Hz, 2H), 1.70 (br, 6H), 1.57 (d, J=15.9 Hz, 18H), 1.52-1.31 (m, 10H), 1.31-0.97 (m, 12H). ¹³C NMR (126 MHz, CDCl₃) δ 35.70, 34.86 (d, J=12.5 Hz), 32.89, 32.62, 27.57, 27.42, 26.96, 26.13 (d, J=5.4 Hz), 24.50, 23.21, 15.09 (d, J=38.8 Hz). ³¹P NMR (162 MHz, CDCl₃) δ 32.71. ¹¹B NMR (128 MHz, CDCl₃) δ 84.01.

### Synthesis: Dicyclohexyl(pent-4-en-1-yl)phosphonium bromide

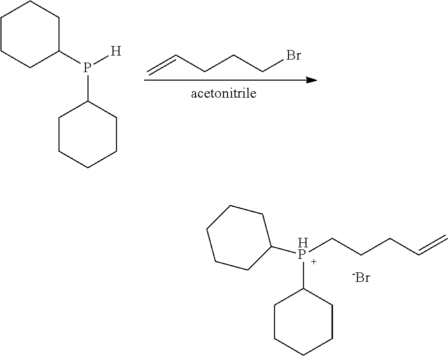

Dicyclohexyl(pent-4-en-1-yl)phosphonium bromide (C₁₇H₃₂BrP). Dicyclohexylphosphine (2.00 g, 10.1 mmol) and 5-Bromo-1-pentene (1.64 g, 11.1 mmol) in acetonitrile (10 ml) were combined and stirred at 95° C. for 12 hours. The solvent was then removed under vacuo. The crude was washed by pentane and diethyl ether to obtain pure product as a white solid (3.50 g, 93%). ¹H NMR (400 MHz, CDCl₃) δ 7.90 (d, J_{PH}=490.0 Hz, 1H), 5.95-5.54 (m, 1H), 5.25-4.76 (m, 2H), 2.67-2.56 (m, 2H), 2.32-2.19 (m, 4H), 2.14 (br, 2H), 2.09-2.03 (m, 2H), 1.98-1.84 (m, 7H), 1.83-1.73 (m, 2H), 1.62-1.51 (m, 4H), 1.48-1.36 (m, 4H), 1.35-1.22 (m, 2H). ¹³C NMR (126 MHz, CDCl₃) δ 135.71, 117.42, 34.44 (d, J=14.3 Hz), 28.73 (d, J=41.6 Hz), 27.29 (dd, J=70.1, 3.5 Hz), 26.05 (dd, J=13.0, 11.2 Hz), 25.10 (d, J=1.7 Hz), 23.08 (d, J=4.5 Hz), 13.45 (d, J=42.8 Hz). ³¹P NMR (202 MHz, CDCl₃) δ 17.94.

### Synthesis: (5-(9-borabicyclo[3.3.1]nonan-9-yl)pentyl)dicyclohexylphosphonium bromide

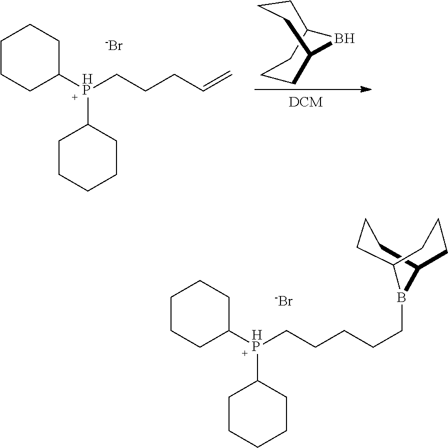

(5-(9-borabicyclo[3.3.1]nonan-9-yl)pentyl)dicyclohexylphosphonium bromide (C₂₅H₄₇BrPB). Mix dicyclohexyl(pent-4-en-1-yl)phosphonium bromide (1.50 g, 4.32 mmol) and 9-BBN (0.55 g, 4.53 mmol) in dichloromethane (15 ml) and stir at room temperature 16 hours. All solvent was then removed under vacuo. The crude product was stirred in pentane (20 ml) for 30 minutes. The pure product (1.74 g, 86%) was obtained by filtration as white solid and was washed by pentane and diethyl ether. ¹H NMR (500 MHz, CDCl₃) δ 7.71 (d, J_{PH}=486.6 Hz, 1H), 2.68-2.53 (m, 2H), 2.23 (br, 2H), 2.11 (br, 2H), 2.07-1.96 (m, 2H), 1.95-0.96 (m, 38H). ¹³C NMR (126 MHz, CDCl₃) δ 34.09 (d, J=13.4 Hz), 33.09, 30.99, 28.63 (d, J=41.6 Hz), 27.58 (d, J=3.4 Hz), 26.99 (d, J=3.6 Hz), 26.03 (dd, J=13.0, 10.2 Hz), 25.09 (d, J=1.6 Hz), 23.93 (d, J=5.1 Hz), 23.79, 23.13, 14.24 (d, J=41.9 Hz). ³¹P NMR (162 MHz, CDCl₃) δ 18.31. ¹¹B NMR (128 MHz, CDCl₃) δ 87.57.

### Synthesis: Di(adamantan-1-yl)(pent-4-en-1-yl)phosphonium bromide

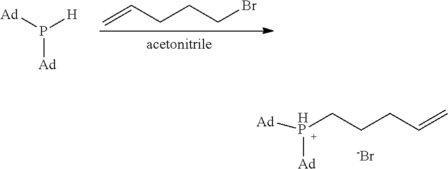

Di(adamantan-1-yl)(pent-4-en-1-yl)phosphonium bromide (C₂₅H₄₀BrP). Diadamantanylphosphine (5.00 g, 16.5 mmol) and 5-Bromo-1-pentene (7.39 g, 49.6 mmol) in acetonitrile (20 ml) and THF (10 ml) were combined and stirred at 85° C. for 12 hours. The solvent was then removed under vacuo. The crude was washed by pentane to obtain pure product as a white solid (6.55 g, 87.8%). ¹H NMR (400 MHz, CDCl₃) δ 8.47 (s, 1H), 5.78-5.65 (m, 1H), 5.26-4.65 (m, 2H), 2.21-2.14 (m, 4H), 2.11-2.05 (m, 2H), 1.96 (br, 30H). ¹³C NMR (126 MHz, CDCl₃) δ 135.94, 117.31, 38.00 (d, J=2.4 Hz), 37.39 (d, J=33.1 Hz), 35.59 (d, J=1.7 Hz), 34.61 (d, J=12.7 Hz), 27.42 (d, J=9.4 Hz), 25.67 (d, J=5.1 Hz), 10.83 (d, J=40.1 Hz). ³¹P NMR (202 MHz, CDCl₃) δ 22.76.

### Synthesis: (5-(9-borabicyclo[3.3.1]nonan-9-yl)pentyl)di(adamantan-1-yl)phosphonium bromide

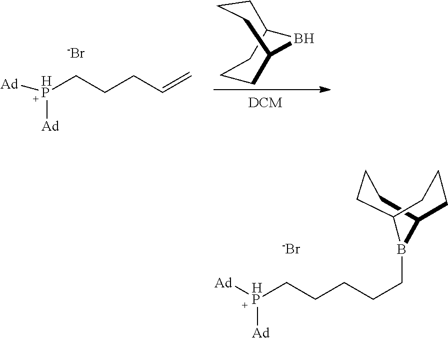

(5-(9-borabicyclo[3.3.1]nonan-9-yl)pentyl)di(adamantan-1-yl)phosphonium bromide (C₃₃H₅₅BrPB). ag8871 Mix di(adamantan-1-yl)(pent-4-en-1-yl)phosphonium bromide (4.07 g, 9.0 mmol) and 9-BBN (1.15 g, 9.46 mmol) in dichloromethane (80 ml) and stir at room temperature 16 hours. All solvent was then removed under vacuo. The crude product was stirred in pentane (20 ml) for 30 minutes. The pure product (4.60 g, 89%) was obtained by filtration as white solid and was washed by pentane and diethyl ether. ¹H NMR (500 MHz, CDCl₃) δ 8.13 (d, J=482.2 Hz, 1H), 2.24 (br, 10H), 2.19-2.00 (m, 7H), 1.99-1.75 (m, 17H), 1.75-1.47 (m, 9H). 1.45-1.04 (m, 7H), 0.88 (t, J=6.8 Hz, 4H). ¹³C NMR (126 MHz, CDCl₃) δ 38.14 (d, J=2.5 Hz), 37.36 (d, J=33.0 Hz), 35.65 (d, J=1.6 Hz), 34.47 (d, J=12.3 Hz), 34.11, 33.12, 31.04, 27.48 (d, J=9.4 Hz), 26.38 (d, J=5.4 Hz), 23.72, 23.18, 22.33, 14.05, 12.01 (d, J=39.2 Hz). ³¹P NMR (162 MHz, CDCl₃) δ 21.69. ¹¹B NMR (128 MHz, CDCl₃) δ 87.37.

### Synthesis: (1R,5R,8S)-4,8-dimethyl-2-(pent-4-en-1-yl)-2-phosphabicyclo[3.3.1]nonan-2-ium bromide

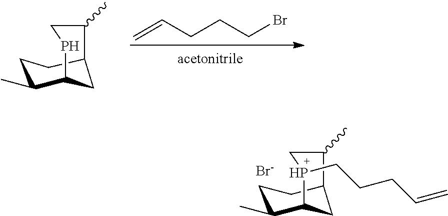

(1R,5R,8S)-4,8-dimethyl-2-(pent-4-en-1-yl)-2-phosphabicyclo[3.3.1]nonan-2-ium bromide (C₁₅H₂₈BBrPB). To the toluene (60 wt %) solution of (1R,5R,8S)-4,8-dimethyl-2-phosphabicyclo[3.3.1]nonane (5.99 g, 21.1 mmol, two isomers), purchased from Strem, was added 5-bromopent-1-ene (3.14 g, 21.1 mmol) in 20 ml of acetonitrile. The solution was heated to 85° C. for 16 hours. The solvent was removed and the solids were triturated with several 10 ml portions of hexane until a white powder was obtained. The solid was dried under vacuum. The product was isolated as a white solid (6.00 g, 89.1%, four isomers). ¹H NMR (500 MHz, C₆D₆) δ 9.20 (br, PH), 8.86 (br, PH), 8.17 (br, PH), 7.86 (d, J=38.3 Hz, PH), 6.34-5.75 (m, 1H), 5.25 (d, J=17.2 Hz, 1H), 5.09 (d, J=10.2 Hz, 1H), 3.73-2.25 (m, 7H), 2.21-0.61 (m, 17H). ¹³C NMR (126 MHz, C₆D₆) δ 137.87, 137.66, 137.61, 137.59, 115.69, 115.67, 115.64, 115.59, 36.30 (d, J=1.8 Hz), 35.92 (d, J=2.5 Hz), 35.28, 34.94 (d, J=1.9 Hz), 34.65, 34.57, 34.53, 34.49, 34.45, 34.43, 34.37, 34.31, 34.21, 33.72 (d, J=4.6 Hz), 33.65 (d, J=5.4 Hz), 33.13 (d, J=6.8 Hz), 32.81 (d, J=9.3 Hz), 31.97 (d, J=6.2 Hz), 31.84 (d, J=4.2 Hz), 31.71, 31.30, 30.59 (d, J=2.6 Hz), 30.29, 29.90 (d, J=2.3 Hz), 29.66 (d, J=5.2 Hz), 28.53, 28.38, 28.22, 28.07, 27.99 (d, J=2.7 Hz), 27.48 (d, J=2.6 Hz), 27.16 (d, J=3.0 Hz), 24.61 (d, J=14.6 Hz), 24.46, 24.01, 23.21 (d, J=4.3 Hz), 23.07 (d, J=3.9 Hz), 22.78, 22.46, 22.35 (d, J=4.0 Hz), 21.95, 21.68 (d, J=14.5 Hz), 21.27, 21.12 (d, J=0.8 Hz), 21.08 (d, J=0.9 Hz), 20.99 (d, J=3.8 Hz), 20.95, 20.77, 20.44, 20.22 (d, J=3.8 Hz), 20.07, 19.74, 19.50, 19.14 (d, J=3.3 Hz), 17.92, 17.85, 17.80, 17.78, 17.56. ³¹P NMR (202 MHz, C₆D₆) δ 7.35 (d, J=509.2 Hz), −0.39 (d, J=501.7 Hz), −5.51 (d, J=489.5 Hz), −9.27 (d, J=516.6 Hz).

### Synthesis: (1R,5R,8S)-2-(5-(9-borabicyclo[3.3.1]nonan-9-yl)pentyl)-4,8-dimethyl-2-phosphabicyclo[3.3.1] nonan-2-ium bromide

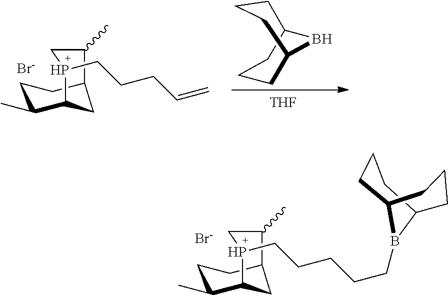

(1R,5R,8S)-2-(5-(9-borabicyclo[3.3.1]nonan-9-yl)pentyl)-4,8-dimethyl-2-phosphabicyclo[3.3.1]nonan-2-ium bromide (C₂₃H₄₃BBrPB). (1R,5R,8S)-4,8-dimethyl-2-(pent-4-en-1-yl)-2-phosphabicyclo[3.3.1]nonan-2-ium bromide (3.00 g, 9.40 mmol) was mixed in a dichloromethane (15 ml) solution of 9-BBN (1.15 g, 9.40 mmol). The mixture was stirred for 16 hours at room temperature. The solution was concentrated to approximately 1 ml and 20 ml of pentane was added precipitating a white powder (2.20 g, 53.1%, four isomer).

¹H NMR (500 MHz, C₆D₆) δ 8.02 (br, PH), 7.92 (br, PH), 7.02 (br, PH), 6.94 (br, PH), 3.03-1.96 (m, 5H), 1.96-1.16 (m, 28H), 1.14-1.02 (m, 3H), 0.90 (dd, J=15.6, 6.5 Hz, 6H).

¹³C NMR (126 MHz, C₆D₆) δ 36.03 (d, J=2.1 Hz), 35.73 (d, J=2.3 Hz), 34.93 (d, J=2.2 Hz), 34.73 (d, J=2.0 Hz), 34.06 (d, J=4.8 Hz), 33.91 (d, J=2.2 Hz), 33.77, 33.63 (d, J=3.3 Hz), 33.54, 33.50, 33.36 (d, J=5.2 Hz), 33.30, 33.03 (d, J=0.7 Hz), 32.41 (d, J=7.0 Hz), 32.33, 32.15 (d, J=9.5 Hz), 32.04 (d, J=3.4 Hz), 31.46 (d, J=6.0 Hz), 31.41, 31.35 (d, J=4.1 Hz), 30.91 (br), 30.16 (m), 29.55 (d, J=5.4 Hz), 29.01, 28.70, 28.46, 28.15 (d, J=2.3 Hz), 28.03, 27.84 (d, J=2.8 Hz), 27.82-27.53 (m), 27.07 (d, J=3.1 Hz), 26.81 (d, J=2.7 Hz), 24.43 (d, J=13.4 Hz), 24.18, 23.94, 23.87 (d, J=10.2 Hz), 23.59 (d, J=4.5 Hz), 23.24 (d, J=4.5 Hz), 23.10, 22.84, 22.72 (d, J=4.7 Hz), 22.52, 22.09, 21.90, 21.78, 21.74, 21.66, 21.24 (d, J=1.4 Hz), 21.07, 20.75, 20.71 (d, J=4.0 Hz), 20.12 (d, J=4.1 Hz), 19.96, 19.61, 18.09 (d, J=46.2 Hz), 17.31 (d, J=47.2 Hz). ³¹P NMR (202 MHz, C₆D₆) δ 8.57 (d, J=497.4 Hz), 1.18 (d, J=465.1 Hz), −4.53 (d, J=488.0 Hz), −8.90 (d, J=491.5 Hz). ¹¹B NMR (128 MHz, C₆D₆) δ 87.95

### Comparing Tertiary and Quaternary Phosphonium-Borane Systems

The disclosed tertiary phosphonium-borane catalysts are more active for CO₂/epoxide copolymerization at higher temperatures when compared to the quaternary phosphonium-borane system. The tertiary phosphonium-borane catalysts remain highly active at high temperatures in the present of a large excess of chain-transfer-agents. In solution polymerization, it is desirable to perform the polymerization at high temperatures. These statements are supported by Examples 3, 4, 12, 14, 22, 24, 26, 28, 30, 32, 34, 36, 38, 39, 52.

### Polymerization Examples of CO₂ and Cyclohexene Oxide (CHO)

The polymerization of CO₂ and cyclohexene oxide (CHO) were performed in a stainless steel vessel. The catalyst was firstly dissolved in 100 uL epoxide with respective epoxide/catalyst mole ratios. Then, the vessel was pressurized with 450 psi CO₂, isolated, and heated at respective temperatures for 12 hours. The reaction was then brought back to ambient temperature and depressurized. The reaction mixture was then dissolved in 1 mL CDCl₃ containing 1,3-bis(trimethylsilyl)benzene (5 mM) as an internal standard for quantification. The tune over number (TON), corresponding to numbers of epoxides converted into polymers per catalyst, was determined by ¹H NMR spectroscopy. The polymers were isolated by drying in a vacuum oven. The molecular weights were determined by GPC methods using dn/dc value of 0.089 mL/g.

TABLE 1
CO₂ and cyclohexene oxide (CHO) polymerization examples.

| | | | | Turnover | | | | |
|---|---|---|---|---|---|---|---|---|
| | | Monomer | Chain transfer | Number | Polycarbonate | | | |
| | Catalyst | to cat mol | agent (DHCH) | (TON) for | yield | Temp | Mw | Mn |
| Ex. | Complex | ratio | to cat mol ratio | polycarbonate | (mg) | (° C.) | (g/mol) | (g/mol) |
| 1 | 6 | 10000 | 0 | 3884 | 55 | 80 | 27066 | 25067 |
| | (comparative) | | | | | | | |
| 2 | 6 | 10000 | 100 | 2386 | 34 | 80 | —a | —a |
| | (comparative) | | | | | | | |
| 3 | 6 | 10000 | 0 | 264 | 4 | 100 | 4070 | 2466 |
| | (comparative) | | | | | | | |
| 4 | 6 | 10000 | 100 | 77 | 1 | 100 | —a | —a |
| | (comparative) | | | | | | | |
| 5 | 2 | 1000 | 0 | 392 | 55 | 80 | 21433 | 19380 |
| 6 | 2 | 5000 | 0 | 1682 | 47 | 80 | 29916 | 28427 |
| 7 | 2 | 10000 | 0 | 1894 | 27 | 80 | 16034 | 14787 |
| 8 | 2 | 5000 | 20 | 1958 | 55 | 80 | 10791 | 10044 |
| 9 | 2 | 10000 | 100 | 2181 | 31 | 80 | 4287 | 4244 |
| 10 | 2 | 1000 | 0 | 426 | 60 | 100 | 22166 | 17521 |
| 11 | 2 | 5000 | 0 | 1885 | 53 | 100 | 27520 | 24481 |
| 12 | 2 | 10000 | 0 | 3401 | 48 | 100 | 29400 | 27052 |
| 13 | 2 | 5000 | 20 | 2368 | 67 | 100 | 10706 | 9906 |
| 14 | 2 | 10000 | 100 | 3938 | 55 | 100 | 5474 | 5322 |
| 15 | 4 | 1000 | 0 | 493 | 69 | 80 | 23160 | 21632 |
| 16 | 4 | 5000 | 0 | 1523 | 43 | 80 | 24897 | 23318 |
| 17 | 4 | 10000 | 0 | 1539 | 22 | 80 | 15396 | 14418 |
| 18 | 4 | 5000 | 20 | 2010 | 56 | 80 | 11660 | 11011 |
| 19 | 4 | 10000 | 100 | 2149 | 30 | 80 | 4471 | 4429 |
| 20 | 4 | 1000 | 0 | 475 | 67 | 100 | 19632 | 67568 |
| 21 | 4 | 5000 | 0 | 1805 | 51 | 100 | 26070 | 256616 |
| 22 | 4 | 10000 | 0 | 3328 | 47 | 100 | 24542 | 473105 |
| 23 | 4 | 5000 | 20 | 2015 | 57 | 100 | 11239 | 13637 |
| 24 | 4 | 10000 | 100 | 3702 | 52 | 100 | 5599 | 5210 |
| 25 | 5 | 1000 | 0 | 495 | 70 | 110 | 24622 | 20798 |
| 26 | 5 | 10000 | 0 | 4089 | 57 | 110 | 27721 | 25786 |
| 27 | 5 | 1000 | 0 | 464 | 65 | 120 | 30941 | 25187 |
| 28 | 5 | 10000 | 0 | 3920 | 55 | 120 | 26036 | 24281 |
| 29 | 5 | 1000 | 0 | 426 | 60 | 130 | 25522 | 16220 |
| 30 | 5 | 10000 | 0 | 4193 | 59 | 130 | 27499 | 25121 |
| 31 | 5 | 10000 | 0 | 4385 | 62 | 140 | 25181 | 21462 |
| 32 | 3 | 1000 | 0 | 363 | 51 | 80 | 22851 | 21254 |
| 33 | 3 | 1000 | 0 | 376 | 53 | 100 | 19613 | 16560 |
| 34 | 1 | 1000 | 0 | 454 | 64 | 80 | 19965 | 18177 |
| 35 | 1 | 5000 | 0 | 1555 | 44 | 80 | 23799 | 20456 |
| 36 | 1 | 10000 | 0 | 1712 | 24 | 80 | 13224 | 11722 |
| 37 | 1 | 5000 | 20 | 2192 | 62 | 80 | 11897 | 11082 |
| 38 | 1 | 10000 | 100 | 1598 | 22 | 80 | 4091 | 3899 |

aFootnote:
molecular weight not determined

### Polymerization Examples of Beta-Butyrolactone (BBL)

The polymerization of beta-butyrolactone (BBL) were performed in a stainless steel vessel. The catalyst was firstly dissolved in 100 uL epoxide with respective monomer/catalyst mole ratios. Then, the vessel was isolated and heated at respective temperatures for 12 hours. The reaction was then brought back to ambient temperature. The reaction mixture was then dissolved in 1 mL CDCl₃ containing 1,3-bis(trimethylsilyl)benzene (5 mM) as an internal standard for quantification. The tune over number (TON), corresponding to numbers of beta-butyrolactone converted into polymers per catalyst, was determined by ¹H NMR spectroscopy. The polymers were isolated by drying in a vacuum oven.

TABLE 2
beta-butyrolactone (BBL) polymerization examples.

| | | Monomer | Chain transfer | Turnover Number | Polyhydroxy | |
|---|---|---|---|---|---|---|
| | Catalyst | to cat mol | agent (DHCH) | (TON) for | butyrate | Temp |
| Ex. | Complex | ratio | to cat mol ratio | polyhydroxybutyrate | yield (mg) | (° C.) |
| 39 | 2 | 500 | 0 | 149 | 32 | 80 |
| 40 | 2 | 1000 | 0 | 237 | 25 | 80 |
| 41 | 2 | 1000 | 5 | 241 | 13 | 80 |
| 42 | 2 | 500 | 0 | 337 | 71 | 100 |
| 43 | 2 | 1000 | 0 | 643 | 68 | 100 |
| 44 | 2 | 2000 | 0 | 806 | 43 | 100 |
| 45 | 2 | 5000 | 0 | 1412 | 30 | 100 |
| 46 | 2 | 1000 | 5 | 622 | 66 | 100 |
| 47 | 4 | 500 | 0 | 168 | 35 | 80 |
| 48 | 4 | 1000 | 0 | 198 | 21 | 80 |
| 49 | 4 | 1000 | 5 | 241 | 13 | 80 |
| 50 | 4 | 500 | 0 | 323 | 68 | 100 |
| 51 | 4 | 1000 | 0 | 487 | 51 | 100 |
| 52 | 4 | 2000 | 0 | 926 | 49 | 100 |
| 53 | 4 | 5000 | 0 | 1548 | 33 | 100 |
| 54 | 4 | 1000 | 5 | 652 | 69 | 100 |

^{a}Footnote:
molecular weight not determined

### Polymerization Examples in the Parr Reactors

Example 55: Synthesis of polycyclohexene carbonate polyol (PCHC, EXP-AG8872). To a Parr reactor was charged with Catalyst 2 (62 mg), cyclohexene oxide CHO (150 mL), and trans-1,2-dihydroxycyclohexane DHCH (861 mg), with a catalyst/CHO/DHCH mol ratio of 1/10,000/50. The reactor was then pressurized with a steady-state CO₂ pressure of 400 psi and heated at 115° C. for 14 hours. The polymerization was terminated by cooling down to ambient temperatures, followed by the release of CO₂. An aliquot was extracted for ¹H NMR analysis (CDCl₃), revealing that 75.6% of cyclohexene oxide was converted into polycyclohexene carbonate, corresponding to a TON of 7560. Around 250 mL dichloromethane was added. The mixture was transferred into a large beaker, and all volatiles were removed under reduced pressure at 90° C., yielding a white solid. The solid was further washed with methanol and dried under vacuum at 90° C. to give 158 g polymer. ¹H NMR analysis of polymer end groups revealed a molar mass of 14,297 g/mol.

Example 56: Synthesis of poly 4-vinyl-1-cyclohexene 1,2-epoxide (PVCHC). To a Parr reactor was charged with Catalyst 11 (135 mg) and 4-vinyl-1-cyclohexene 1,2-epoxide VCHO (40 mL) with a catalyst/VCHO mol ratio of 1/1,000. The reactor was then pressurized with a steady-state CO₂ pressure of 400 psi and heated at 100° C. for 1 hour. The polymerization was terminated by cooling down to ambient temperatures, followed by the release of CO₂. An aliquot was extracted for ¹H NMR analysis (CDCl₃), revealing that 69.0% of 4-vinyl-1-cyclohexene 1,2-epoxide was converted into polycarbonate, corresponding to a TON of 690. Around 100 mL dichloromethane was added. The mixture was transferred into a large beaker, and all volatiles were removed under reduced pressure at 90° C., yielding a white solid. The solid was further washed with diethyl ether and dried under vacuum at 90° C. to give 35.2 g polymer.

### OTHER EMBODIMENTS

Exemplary polymerization conditions include a polymerization temperature between 100° C. and 180° C.

The feed can comprise carbon dioxide at a temperature higher or equal to 31° C. and at a pressure of at least 1,070 psig.

The oxygen-containing polymer resulting from an exemplary process described above can comprise a polymer with a polyether content less than 15 wt %, as measured by proton NMR spectroscopy.

In an exemplary embodiment, the feed can comprise a lactone, wherein the lactone is an enantiomerically enriched chiral lactone, preferably a chiral lactone with an enantiomeric ratio greater than or equal to 60:40.

In an exemplary embodiment, the oxygen-containing polymer that results from an exemplary process described above can comprise a polyester with 0.1 to 2.0 olefinic end groups per polymer chain.

Exemplary embodiments described above can further comprise obtaining less than 15 wt % cis and trans crotonic acid as a coproduct.

All documents described herein are incorporated by reference herein, including any priority documents and/or testing procedures to the extent they are not inconsistent with this text. As is apparent from the foregoing general description and the specific embodiments, while forms of the invention have been illustrated and described, various modifications can be made without departing from the spirit and scope of the invention. Accordingly, it is not intended that the invention be limited thereby. Likewise, the term “comprising” is considered synonymous with the term “including.” Likewise whenever a composition, an element or a group of elements is preceded with the transitional phrase “comprising”, it is understood that we also contemplate the same composition or group of elements with transitional phrases “consisting essentially of,” “consisting of”, “selected from the group of consisting of,” or “is” preceding the recitation of the composition, element, or elements and vice versa.

1. A polymerization process comprising:
Contacting, under polymerization conditions, a feed comprising at least one oxygen-containing monomer with a catalyst system comprising an catalyst compound of Formula (I), an optional co-activator, and an optional chain-transfer agent, and obtaining an oxygen-containing polymer,
wherein, the feed comprises,
at least one epoxide and one or more of CO₂, COS, CS₂, or
at least one epoxide and at least one cyclic anhydride, or
at least one lactone or at least one lactide, and
the catalyst compound is represented by Formula (I), 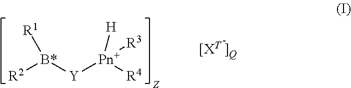
where Pn is a group 15 pnictogen element,
Pn+ constitutes a cationic tertiary pnictogenium moiety wherein the pnictogen is covalently bonded to one hydrogen atom, as well as non-hydrogen Y, R³, and R⁴ groups,
(the number of pnictogenium moieties, Pn+)×Z=T×Q,
B* is a group 13 element;
Z is 1, 2, 3, 4, 5, 6, 7, 8, 9, or 10; where if Z is greater than 1, then the catalyst units are present individually or are bound together in linear, branched or cyclic groups,
T is 1, 2, 3, 4, 5, 6, 7, 8, 9, or 10, indicating the anionic charge of X,
Q is 1, 2, 3, 4, 5, 6, 7, 8, 9, or 10, indicating the number of X present,
each of R¹, R², R³ and R⁴ is independently a hydrocarbyl group, a non-halogenated substituted hydrocarbyl, or a heteroatom-containing group, and can optionally comprise a tri-substituted borane or cationic tertiary pnictogenium moiety,
Y is independently a linking group having 1 to 50 non-hydrogen atoms, and
X is independently a mono-anionic group, a multi-anionic group, or a combination thereof.

2. The process of claim 1, wherein the feed comprises one or more epoxide monomers and one or more of CO₂, COS, CS₂, and the oxygen-containing polymer comprises polyalkylene carbonates or polyalkylene ether carbonates.

3. The process of claim 1, wherein the feed comprises one or more epoxide monomers and one or more cyclic anhydrides, and the oxygen-containing polymer comprises poly(epoxide)(cyclic anhydride) or poly(epoxide)(cyclic anhydride) ether.

4. The process of claim 1, wherein the feed comprises one or more lactone or lactide monomers and the oxygen-containing polymer comprises polyester polymers.

5. The process of claim 1, wherein B* is boron and R¹ and R² form a fused ring with B*.

6. The process of claim 1, wherein Pn is phosphorus.

7. The process of claim 1, wherein each R³ and R⁴ is a secondary alkyl, a tertiary alkyl, and R³ and R⁴ are optionally fused to form cyclic or multi cyclic rings.

8. The process of claim 1 wherein Y is a bridging group containing at least one Group 13, 14, 15, or 16 element.

9. The process of claim 1, wherein Y is ER^{y}₂ or (ER^{y}₂)₂, where E is C, Si, or Ge, where each R^{y} is independently, hydrogen, halogen, C₁ to C₂₀ hydrocarbyl or a C₁ to C₂₀ non-halogenated substituted hydrocarbyl, and two R^{y} may optionally form a cyclic structure including aromatic, partially saturated, or saturated cyclic or fused ring system.

10. The process of claim 1, wherein Y is a linking group of formula —(CH₂)ₙ— wherein n=3−8.

11. The process of claim 1, wherein each of R¹, R², R³ and R⁴ is a hydrocarbyl group.

12. The process of claim 1, wherein the catalyst compound is one or more of:

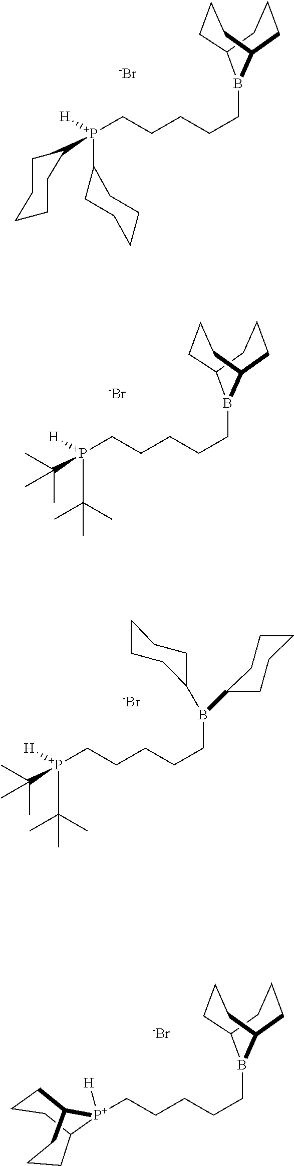

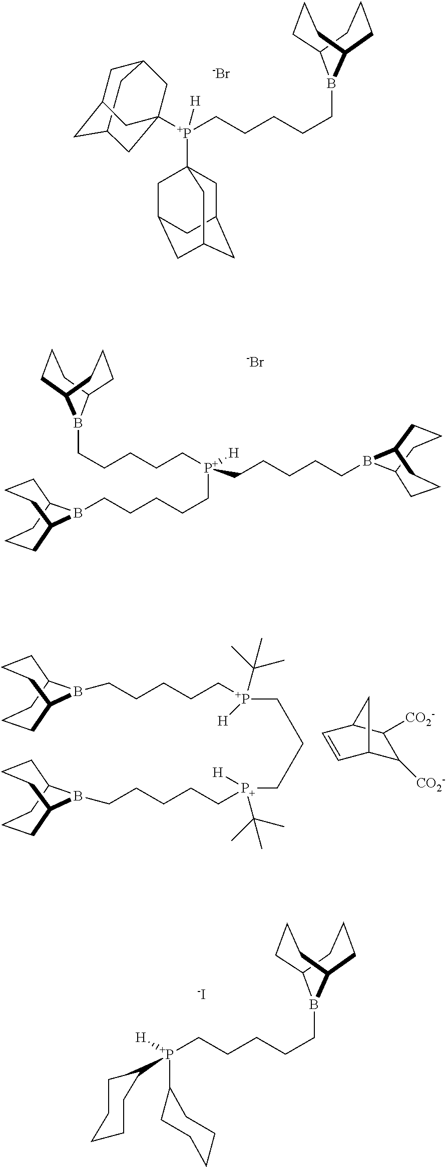

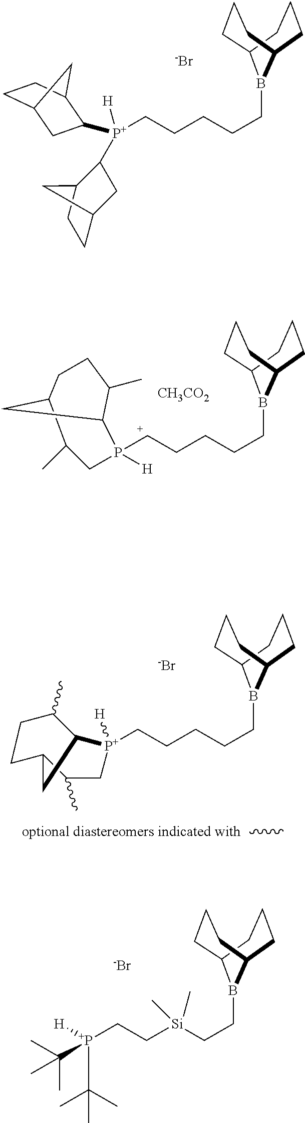

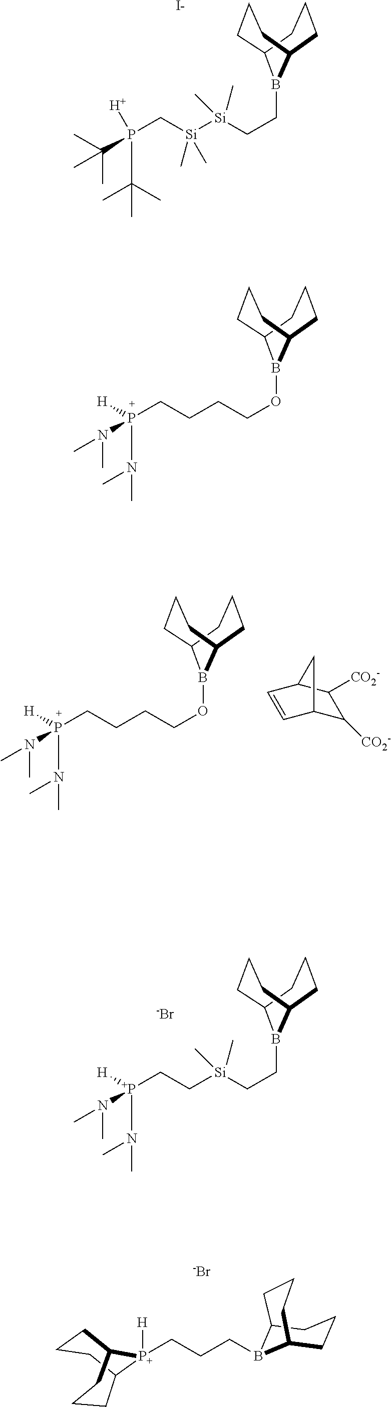

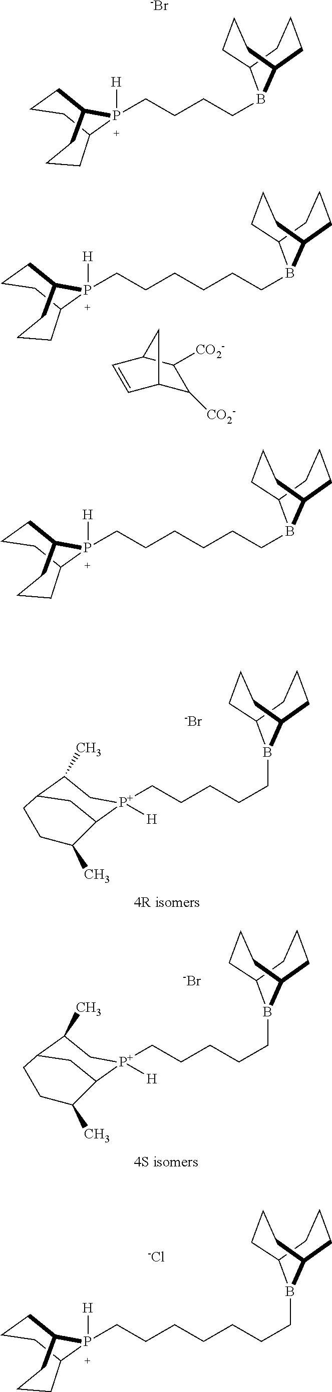

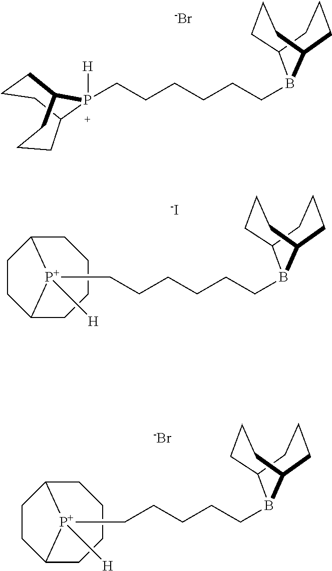

13. The process of claim 1, wherein the chain-transfer-agent is used and is one or more of the following: an alcohol, a carboxylic acid, or a polymer containing at least one hydroxyl group or a carboxylic acid group.

14. The process of claim 1, wherein the co-activator is used and is one or more of the following: triethyl borane, or 1,8-diazabicyclo(5.4.0)undec-7-ene.

15. The process of claim 1, wherein the feed comprises at least two oxygen-containing monomers, introduced to the polymerization reaction simultaneously or sequentially at different time periods, and the oxygen-containing polymer comprises random, gradient, or block copolymers.

16. The process of claim 1, wherein the polymerization conditions include a polymerization temperature between 100° C. and 180° C.

17. The process of claim 2, wherein the feed comprises carbon dioxide and at least one of cyclohexene oxide, vinyl cyclohexene oxide, vinyl cyclohexene dioxide, limonene oxide, limonene dioxide, ethylene oxide, propylene oxide, butylene oxide, glycidyl n-butyl ether, or epichlorohydrin.

18. The process of claim 15, wherein the feed comprises carbon dioxide and at least one of vinyl cyclohexene dioxide or limonene dioxide and the oxygen-containing polymer comprises polyalkylene carbonate polymers comprising pendant cyclic carbonate groups.

19. The process of claim 2, wherein the feed comprises carbon dioxide at a temperature higher or equal to 31° C. and at a pressure of at least 1,070 psig.

20. The process of claim 2, wherein the oxygen-containing polymer comprises a polymer with a polyether content less than 15 wt %, as measured by proton NMR spectroscopy.

21. The process of claim 2, wherein the process further comprises forming a cyclic carbonate.

22. The process of claim 3, wherein the epoxide is one or more of the following: cyclohexene oxide, vinyl cyclohexene oxide, vinyl cyclohexene dioxide, limonene oxide, limonene dioxide, ethylene oxide, propylene oxide, butylene oxide, glycidyl n-butyl ether, or epichlorohydrin.

23. The process of claim 3, wherein the cyclic anhydride is one or more of the following: succinic anhydride, maleic anhydride, glutaric anhydride, phthalic anhydride, or carbic anhydride.

24. The process of claim 4, wherein the lactone is one or more of the following: caprolactone, methyl caprolactone, or decalactone.

25. The process of claim 4, wherein the feed comprises a lactone, wherein the lactone is an enantiomerically enriched chiral lactone.

26. The process of claim 4, wherein the lactone is beta-butyrolactone.

27. The process of claim 24, wherein the oxygen-containing polymer comprises a polyester with 0.1 to 2.0 olefinic end groups per polymer chain.

28. The process of claim 24, wherein the process further comprises obtaining less than 15 wt % cis and trans crotonic acid as a coproduct.

29. A catalyst compound represented by Formula (I): 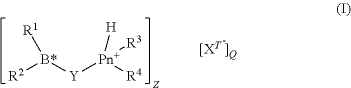
where Pn is a group 15 pnictogen element,
Pn+ constitutes a cationic tertiary pnictogenium moiety wherein the pnictogen is covalently bonded to one hydrogen atom, Y, R³, and R⁴,
(the number of pnictogenium moieties, Pn+)×Z=T×Q,
B* is a group 13 element;
Z is 1, 2, 3, 4, 5, 6, 7, 8, 9, or 10; where if Z is greater than 1, then the catalyst units are present individually or are bound together in linear, branched or cyclic groups,
T is 1, 2, 3, 4, 5, 6, 7, 8, 9, or 10, indicating the anionic charge of X,
Q is 1, 2, 3, 4, 5, 6, 7, 8, 9, or 10, indicating the number of X present,
each of R¹, R², R³ and R⁴ is independently a hydrocarbyl group, a non-halogenated substituted hydrocarbyl, or a heteroatom-containing group, and can optionally comprise a tri-substituted borane or cationic tertiary pnictogenium moiety,
R¹, R², R³, R⁴, and Y do not comprise a Group 1 to 12 elements except optionally hydrogen,
Y is independently a saturated linking group having 3 to 50 Group 14 atoms, and
X is independently a mono-anionic group, a multi-anionic group, or a combination thereof.

30. The catalyst compound of claim 29, wherein B* is boron and R¹ and R² form a fused ring with B*.

31. The catalyst compound of claim 29, wherein Pn is phosphorus and at least one of R³ or R⁴ is a secondary alkyl, a tertiary alkyl, and R³ and R⁴ are optionally fused to form cyclic or multi cyclic rings.

32. The catalyst compound of claim 29, wherein Y is a bridging group containing at least one Group 13, 14, 15, or 16 element.

33. The catalyst compound of claim 29, wherein Y is represented by the formula ER^{y}₂ or (ER^{y}₂)₂, where E is C, Si, or Ge, where each R^{y} is, independently, hydrogen, halogen, C₁ to C₂₀ hydrocarbyl or a C₁ to C₂₀ substituted hydrocarbyl, and two R^{y} may optionally form a cyclic structure including aromatic, partially saturated, or saturated cyclic or a fused ring system.

34. The catalyst compound of claim 29, wherein Y is a linking group of formula —(CH₂)ₙ— wherein n=3.

35. The catalyst compound of claim 29, wherein the catalyst compound is one or more of: 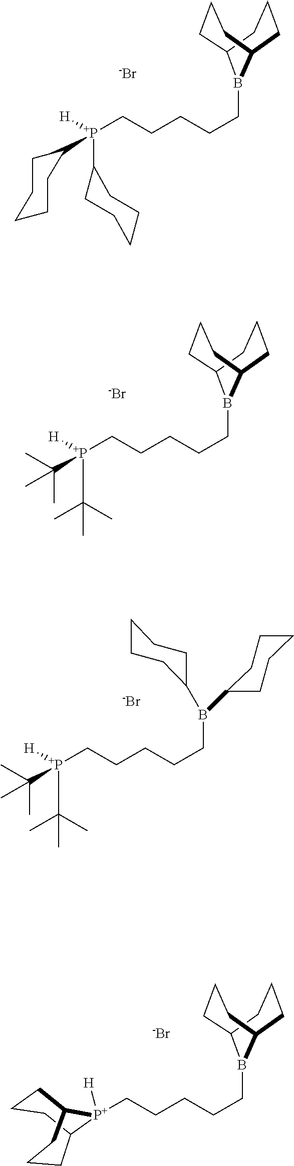 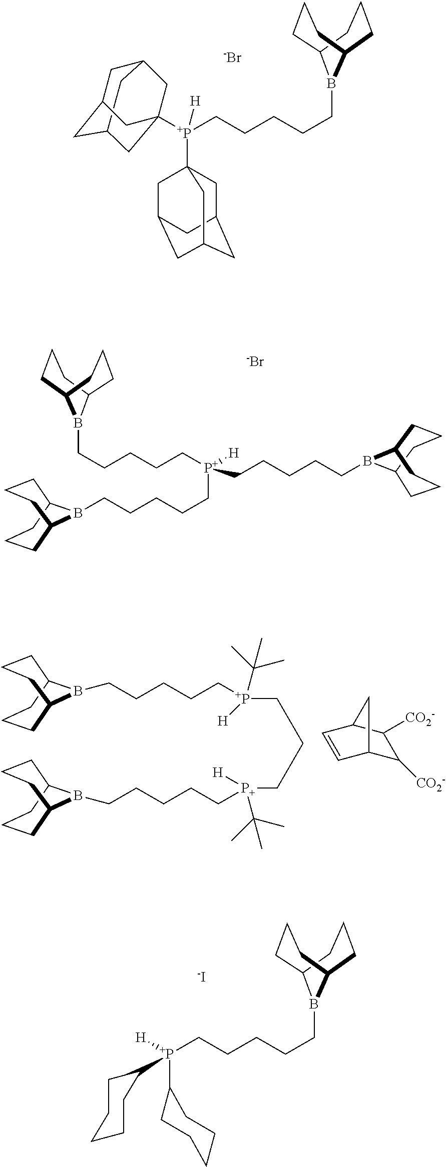 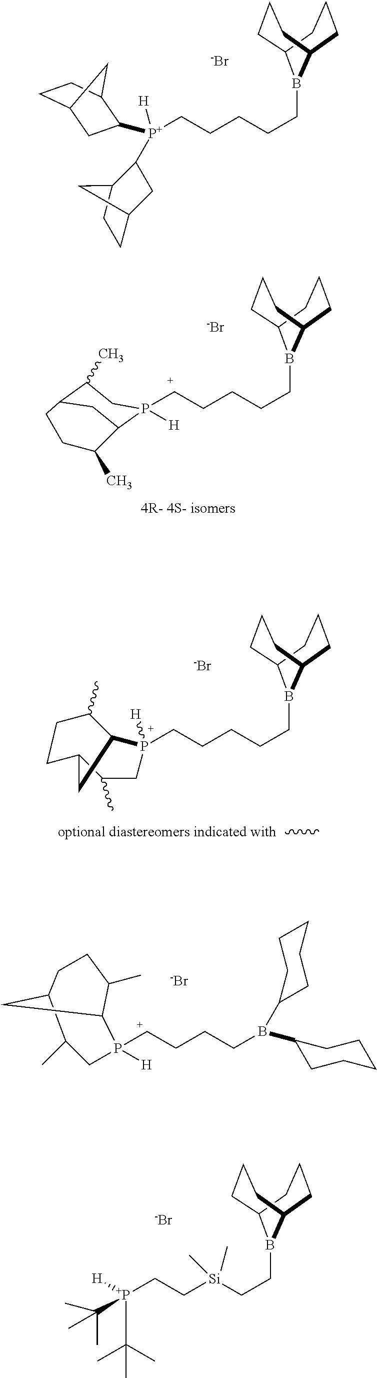 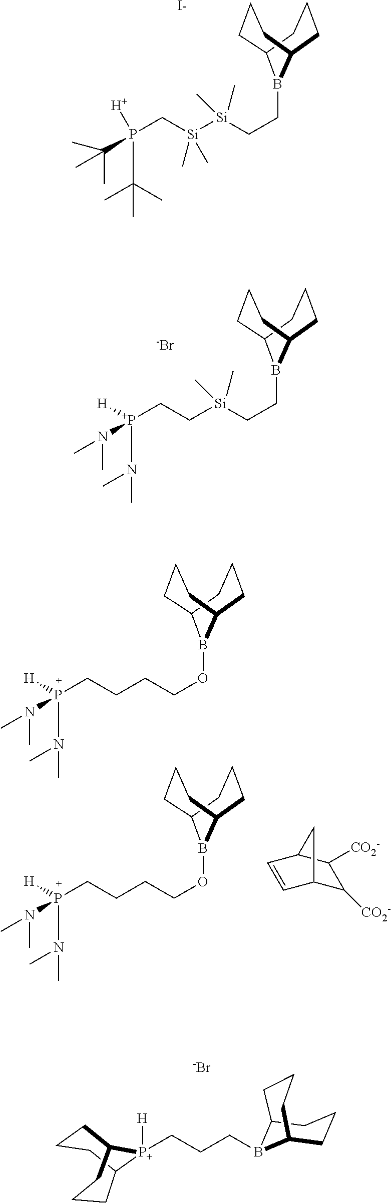 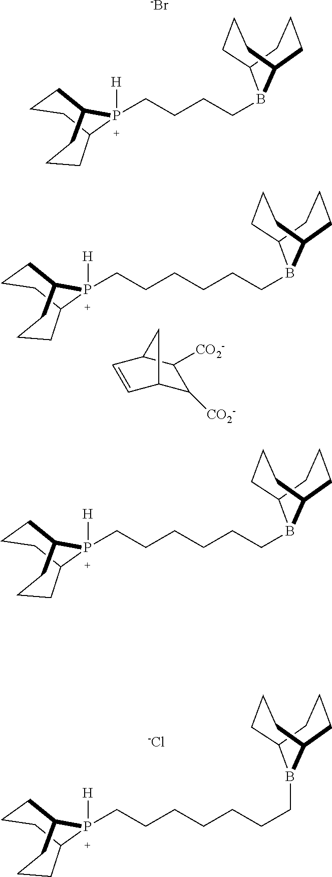 [chemical structure]
